(19) United States
(12) Patent Application Publication
(10) Pub. No.: US 2026/0340639 A1
(43) Pub. Date: Oct. 29, 2026

(54) LOCAL AI FRAUD DETECTION AND PREVENTION

(71) Applicant: U.S. Bank National Association, Minneapolis, MN (US)

(72) Inventor: Muthu SELVAM, Huntersville, NC (US)

(21) Appl. No.: 19/190,543

(22) Filed: Apr. 25, 2025

(51) Int. Cl. G06Q 20/40

(52) U.S. Cl. CPC G06Q 20/4016

(57) ABSTRACT

Improved fraud detection client systems are provided. A transaction attempt and associated transaction dataset are received. Transaction object features are extracted from the transaction dataset. A fraudulent risk score is determined by inputting the transaction object features to a local fraud detection model. The local fraud detection model is (i) configured for execution by the client system, (ii) trained based on a historical transaction dataset and a historical user transaction dataset, and (iii) configured to identify fraudulent transaction attempts in real-time. Generating a fraudulent risk score comprises determining feature variance metrics defining a degree of variance between a subject transaction feature and an associated baseline transaction pattern object feature of a user profile and generating the fraudulent risk score based on an aggregation of feature variance metrics. A remediation action is executed responsive to determining that the fraudulent risk score exceeds a fraudulent risk score threshold.

### FIELD

The present application is generally related to systems, methods, apparatuses, and computer program products associated with fraud prevention and detection, and more specifically to AI-driven fraud detection local to a client device.

### BACKGROUND

Fraud is a pervasive issue in many industries worldwide, including finance, healthcare, e-commerce, government, and the like. Fraud detection refers to the process of attempting to identify and prevent fraudulent activities within applications, APIs, systems, transactions, and data. Applicant has identified several problems associated with fraud detection implementations. Through applied ingenuity, the inventors have developed solutions to the aforementioned problems and more, many of which are described with respect to embodiments herein.

### SUMMARY

Embodiments of the present disclosure are directed to a system, computer readable medium, and computer-implemented method for local AI-based fraud detection and prevention.

A client system is provided, the client system comprising one or more processors and at least one non-transitory memory storing instructions that, when executed by the one or more processors, cause the one or more processors to processors to receive a transaction data object comprising a transaction dataset associated with a transaction attempt executed using an application hosted by the client system. The instructions, that when executed by the one or more processors, further cause the one or more processors to extract, from the transaction dataset, one or more transaction object features. The instructions, that when executed by the one or more processors, further cause the one or more processors to generate, based on inputting the one or more transaction object features to a local fraud detection model, a fraudulent risk score associated with the transaction data object, wherein the local fraud detection model is (i) configured for execution by the client system, (ii) trained based on a historical transaction dataset and a historical user transaction dataset, and (iii) configured to identify fraudulent transaction attempts in real-time. Generating a fraudulent risk score associated with the transaction data object comprises, for a subject transaction feature of the one or more transaction object features, determining a set of feature variance metrics defining a degree of variance between the subject transaction feature and an associated baseline transaction pattern object feature of a user profile, and generating the fraudulent risk score based on an aggregation of a plurality of sets of feature variance metrics associated with the one or more transaction object features. The instructions, that when executed by the one or more processors, further cause the one or more processors to execute a remediation action associated with the transaction data object responsive to determining that the fraudulent risk score exceeds a fraudulent risk score threshold.

According to certain embodiments, the local fraud detection model is trained according to normalized historical online transaction data.

According to certain embodiments, the local fraud detection model is trained according to features extracted from the normalized historical online transaction data.

According to certain embodiments, the local fraud detection model is trained according to scaled data corresponding to any of spending patterns, frequency, or geographic locations of transactions.

According to certain embodiments, the instructions, that when executed by the one or more processors, further cause the one or more processors to determine, based on the historical transaction dataset, a baseline user transaction data structure with respect to a plurality of historical transactions.

According to certain embodiments, the local fraud detection model is trained based on the historical transaction dataset and the baseline user transaction data structure.

According to certain embodiments, the instructions, that when executed by the one or more processors, further cause the one or more processors to receive, from a remote server system, federated learning data corresponding to one or more additional client devices configured to implement one or more additional machine learning models. In such embodiments, the instructions, that when executed by the one or more processors, further cause the one or more processors to update the local fraud detection model based on the federated learning data.

According to certain embodiments, the application is a mobile application configured to enable user access to an entity responsible for managing user transactions.

According to certain embodiments, the user profile is platform-specific to user accesses via the mobile application. In such embodiments, the local fraud detection model is configured with a first set of parameters specific to user accesses via the mobile application.

According to certain embodiments, the application is a web browser application by which a user can access a web platform associated with an entity responsible for managing user transactions.

According to certain embodiments, the user profile is platform-specific to user accesses via the web browser application. In such embodiments, the local fraud detection model is configured with a second set of parameters specific to user accesses via the web browser application.

According to certain embodiments, the instructions, that when executed by the one or more processors, further cause the one or more processors to update the user profile based on the transaction attempt responsive to a determination that the fraudulent risk score does not exceed a predefined threshold.

According to certain embodiments, the instructions, that when executed by the one or more processors, further cause the one or more processors to trigger a multifactor authentication mechanism responsive to determining that the fraudulent risk score exceeds a predefined threshold.

One or more non-transitory computer-readable storage media are provided, the one or more non-transitory computer-readable storage media including instructions that, when executed by one or more processors, cause the one or more processors to receive a transaction data object comprising a transaction dataset associated with a transaction attempt executed using an application hosted by the client system. The instructions, that when executed by the one or more processors, further cause the one or more processors to extract, from the transaction dataset, one or more transaction object features. The instructions, that when executed by the one or more processors, further cause the one or more processors to generate, based on inputting the one or more transaction object features to a local fraud detection model, a fraudulent risk score associated with the transaction data object, wherein the local fraud detection model is (i) configured for execution by the client system, (ii) trained based on a historical transaction dataset and a historical user transaction dataset, and (iii) configured to identify fraudulent transaction attempts in real-time. Generating a fraudulent risk score associated with the transaction data object comprises, for a subject transaction feature of the one or more transaction object features, determining a set of feature variance metrics defining a degree of variance between the subject transaction feature and an associated baseline transaction pattern object feature of a user profile, and generating the fraudulent risk score based on an aggregation of a plurality of sets of feature variance metrics associated with the one or more transaction object features. The instructions, that when executed by the one or more processors, further cause the one or more processors to execute a remediation action associated with the transaction data object responsive to determining that the fraudulent risk score exceeds a fraudulent risk score threshold.

According to certain embodiments, the instructions, that when executed by the one or more processors, further cause the one or more processors to update the user profile based on the transaction attempt responsive to a determination that the fraudulent risk score does not exceed a predefined threshold.

According to certain embodiments, the instructions, that when executed by the one or more processors, further cause the one or more processors to receive, from a remote server system, federated learning data corresponding to one or more additional client devices configured to implement one or more additional machine learning models. In such embodiments, the instructions, that when executed by the one or more processors, further cause the one or more processors to update the local fraud detection model based on the federated learning data.

A computer-implemented method comprises receiving, by one or more processors, a transaction data object comprising a transaction dataset associated with a transaction attempt executed using an application hosted by a client system. The computer-implemented further comprises extracting, by the one or more processors and from the transaction dataset, one or more transaction object features. The computer-implemented further comprises generating, by the one or more processors and based on inputting the one or more transaction object features to a local fraud detection model, a fraudulent risk score associated with the transaction data object. The local fraud detection model is (i) configured for execution by the client system, (ii) trained based on a historical transaction dataset and a historical user transaction dataset, and (iii) configured to identify fraudulent transaction attempts in real-time. The local fraud detection model is configured to determine a set of feature variance metrics defining a degree of variance between the subject transaction feature and an associated baseline transaction pattern object feature of a user profile. The local fraud detection model is configured to generate the fraudulent risk score based on an aggregation of a plurality of sets of feature variance metrics associated with the one or more transaction object features. The computer-implemented method further comprises executing, by the one or more processors, a remediation action associated with the transaction data object responsive to determining that the fraudulent risk score exceeds a fraudulent risk score threshold.

According to some embodiments, the computer-implemented method further comprises determining, by the one or more processors and based on the historical transaction dataset, a baseline user transaction data structure with respect to a plurality of historical transactions.

According to some embodiments, the computer-implemented method further comprises updating, by one or more processors, the user profile based on the transaction attempt responsive to a determination that the fraudulent risk score does not exceed a predefined threshold.

According to some embodiments, the computer-implemented method further comprises receiving, by the one or more processors and from a remote server system, federated learning data corresponding to one or more additional client devices configured to implement one or more additional machine learning models. In such embodiments, the computer-implemented method further comprises updating, by one or more processors, the local fraud detection model based on the federated learning data.

Other embodiments include corresponding systems, methods, and computer programs, configured to perform the operations as described herein, encoded on computer storage devices. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for use with embodiments of the present disclosure.

FIG. 2 illustrates an example apparatus configured in accordance with at least one embodiment of the present disclosure.

FIG. 3 is a dataflow diagram depicting example collected transaction data and corresponding feature engineering processes in accordance with at least one embodiment of the present disclosure.

FIG. 4 is a dataflow diagram depicting example dataflow within a federated learning environment in accordance with at least some example embodiments of the present disclosure.

FIG. 5 illustrates a flowchart depicting an example method for preparing data for use with respect to the fraud detection techniques as described herein in accordance with at least one embodiment of the present disclosure.

FIG. 6A illustrates a flowchart depicting an example method for supervised learning model training with respect to the fraud detection techniques as described herein in accordance with at least one embodiment of the present disclosure.

FIG. 6B illustrates a flowchart depicting an example method for supervised learning model training with respect to the fraud detection techniques as described herein in accordance with at least one embodiment of the present disclosure.

FIG. 7 illustrates a flowchart depicting an example method for fraud detection in accordance with at least one embodiment of the present disclosure.

FIG. 8 illustrates a flowchart depicting an example method for fraud detection in accordance with at least one embodiment of the present disclosure.

FIG. 9 discloses an example computing environment with which aspects of the present disclosure may be implemented.

FIG. 10 illustrates an example machine learning framework for use with embodiments of the present disclosure.

### DETAILED DESCRIPTION

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Like numbers refer to like elements throughout.

### Overview

Impersonation and embezzlement impact institutions in terms of financial and operational risks, as well as reputational losses. Fraud detection systems are generally implemented posterior, providing responses sometimes after a fraudulent transaction has already occurred. Conventional anti-fraud techniques, such as rule-based systems and statistical models, involve setting up predetermined parameters to identify transactions based on predetermined traits or limits. Some current anti-fraud techniques leverage decision trees, support vector machines (SVM), and neural networks to identify transaction patterns that conventional rule-based systems cannot, thereby enabling detection of previously unknown fraud patterns. Deep learning implementations enable recognizing fraud patterns in big data where simple models are less likely to detect such patterns, enabling AI models to keep power cycling with new data and improve their ability to predict new forms of fraud.

Anomaly detection is an approach to AI and machine learning-based fraud detection systems. Anomaly detection techniques involve identifying certain transactions that exhibit characteristics which may lead to fraudulent activities. Anomaly detection techniques can be categorized into supervised and unsupervised techniques, wherein supervised learning methods need trained data consisting of labeled inputs and outputs, and unsupervised methods function on the premise of inferring outliers based on recognized untrained data.

The rise of fraudulent banking transactions has caused significant financial losses and reduced customer trust. Traditional post-transaction fraud detection models are insufficient for modern banking needs. For example, traditional backend-based fraud detection systems are often slow, reactive, and prone to inaccuracies, particularly with respect to detecting novel fraud patterns. Moreover, rule-based methods fail to adapt to the dynamic nature of cyber threats, thereby resulting in increased false positives when detecting fraud, while also failing to detect some fraudulent transactions.

Fraud detection systems may rely on rule-based risk scoring systems, where transaction data is sent through backend APIs for processing. These systems can be slow, especially for real-time fraud detection, and often generate false positives. False positives in fraud detection systems can cause unnecessary remediation actions and failed transaction attempts for legitimate users. Further, fraudulent activities are often identified after transactions have been processed, and subsequently require manual reviews and investigations. Such manual intervention increases both the time and costs associated with each instance of fraud prevention.

Embodiments herein provide for enhanced fraud detection speed, privacy, and accuracy. The techniques and framework(s) as described herein include a system configured to use a client device architecture to analyze transactional data, user activity, and geographical distribution(s) using AI and machine learning to detect and prevent fraud before a transaction is executed. By operating directly on client devices and browsers, the fraud detection system(s) as described herein limit reliance on centralized infrastructures, thereby ensuring real-time fraud detection while reducing operational costs. Embodiments of the present disclosure provide techniques for proactively identifying fraud, thereby reducing financial losses associated with fraudulent activity and boosting consumer confidence in digital banking systems.

Embodiments of the present disclosure include a real-time fraud detection and prevention system powered by front-end artificial intelligence (AI) for digital banking applications. By leveraging lightweight machine learning models embedded within mobile and web banking platforms, systems of the present disclosure enable rapid and accurate detection of fraudulent transactions. Embodiments of the present disclosure enable real-time anomaly detection, typical user transaction pattern profiling, device authentication, and risk scoring, thereby significantly reducing false positives while enhancing consumer trust. Embodiments of the present disclosure operate locally on client devices or browsers, thereby providing increased privacy, faster processing, and reduced infrastructure costs for financial institutions.

Embodiments of the present disclosure relate to advanced anomaly detection techniques configured to identify suspicious transactions deviating from established patterns. The techniques as described herein include preprocessing datasets, applying supervised, unsupervised, and federated learning for secure collaborative training of one or more models for identifying fraudulent activity, and implementing said one or more models via a frontend application.

Embodiments of the present disclosure enable real-time fraud detection. By processing transactions in real-time, a detection time for detecting fraudulent activity is reduced. By minimizing the time taken to detect a fraudulent transaction, systems for fraud prevention are able to operate with a higher success rate, as mitigating actions can be taken more immediately. By increasing the accuracy with which fraud prevention systems operate, unnecessary network transmissions associated with fraudulent transactions are minimized or avoided, thereby minimizing the resources required for transaction execution.

Embodiments of the present disclosure enable enhanced privacy with respect to fraud prevention systems. By operating locally on a client device, embodiments of the present disclosure retain sensitive data on client devices. As such, embodiments of the present disclosure enable increased security by minimizing the risk of sensitive data being accessed or transmitted to certain external devices or actors.

Embodiments of the present disclosure further enable platform-specific accuracy with respect to fraud detection. The techniques as described herein tailor fraud detection mechanisms to the unique characteristics of mobile and web platforms, for example, thereby ensuring fraudulent transactions are analyzed according to a model configured to consider characteristics uniquely associated with the subject platform. By leveraging lightweight local fraud detection models, the techniques as described herein ensure that the devices/platforms responsible for executing such local fraud detection models have adequate available resources for detecting fraudulent transactions using the models.

Embodiments of the present disclosure further enable continuous learning with respect to the models configured to detect fraudulent transactions which provides increased accuracy when detecting and preventing fraudulent transactions by regularly updating the models according to most recent transaction attempts and patterns. By enabling continuous learning based on recent transaction attempts, the subject models analyze transactions based on the details of recent transaction attempts and any associated developing transaction trends. Further yet, continuous learning of this nature eliminates the need for additional large training datasets by updating the model based on analyzed transactions. By utilizing federated learning to enhance fraud detection models without sharing specific user data, the techniques as described herein enable consistent adjustment(s) based on new data while still preserving user privacy.

Embodiments of the present disclosure further enable an improved user experience with respect to fraud prevention systems. By reducing false positives, the systems as described herein provide contextual, personalized security measures, thereby increasing the system's ability to provide accurate fraud detection and prevention. Improved fraud detection and prevention of this nature minimizes the negative user experiences associated with incorrectly identified fraudulent transaction attempts, such as the need to attempt transactions more than once, communicate with a managing/overseeing authority to verify activity, and the like.

Mobile and web platforms have specific constraints, such as limited processing power, storage, battery life on mobile devices, and browser rendering limitations. To comply with these constraints, machine learning models as described herein are lightweight. Machine learning model implementations can be made lightweight using techniques such as model pruning and quantization to ensure efficiency without sacrificing accuracy. Additionally, pretrained smaller models can be leveraged to minimize resource requirements. By extracting necessary features locally, data transmissions between a frontend component and a backend component are minimized, thereby further optimizing resource usage.

### Example Terminology

As used herein, the terms “data,” “content,” “digital content,” “digital content object,” “information,” and similar terms may be used interchangeably to refer to data capable of being transmitted, received, and stored in accordance with embodiments of the present disclosure.

Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and the like.

As used herein, the term “circuitry” refers to particular hardware configured to perform the functions associated with the particular circuitry as described herein. In some embodiments, circuitry may be used as part of (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. In some embodiments, “circuitry” may include processing circuitry, storage media, network interfaces, input/output devices, and/or the like. As a further example, as used herein, the term “circuitry” also includes an implementation comprising one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device, and/or other computing device.

As used herein, a “computer-readable storage medium,” refers to a physical storage medium (e.g., volatile, or non-volatile memory device), and may be differentiated from a “computer-readable transmission medium,” which refers to an electromagnetic signal.

As used herein, the terms “data structure,” “data entity,” “data object,” or “data set” may be used interchangeably to refer to data capable of being transmitted, received, and/or stored.

As used herein, the term “access” refers to the ability to receive, retrieve, view, make available, make use of, or the like, various data associated with embodiments described herein.

As used herein, the term “repository,” “database,” and/or the like, may be used to interchangeably refer to a computing location associated with a system where data is stored, accessed, modified, and otherwise maintained by the system. A repository may be used to store data in association with a data storage protocol and/or a query language. In certain embodiments, a repository may embody a data storage device or devices, a separate database server or servers, or as a combination of data storage devices and separate database servers. Further, in some embodiments, a repository may be embodied as a distributed repository such that some of the stored data is stored centrally in a location within the repository and other data stored in a single remote location or a plurality of remote locations. Alternatively, in some embodiments, a repository may be distributed over a plurality of remote storage locations only such as in a cloud storage environment.

As used herein, the terms “web application system,” “web application,” “subject Web application system,” “subject system,”, and “subject web application configuration system” may be used to interchangeably refer to a software program stored on a remote server and accessed through a web browser. Web application systems as used herein may be designed to be interactive and allow users to send and receive data between the web browser and the server. In at least some embodiments, a web application system includes combinations of components configured to provide the functionality via which the user can interact with data displayed or otherwise presented by the web application system.

As used herein, the term “application programming interface” (or “API”) may be used to refer to a set of rules and protocols that allow different software applications to communicate and share data with one another. The term API may refer to software configured to enable the exchange of data between computer program products, components, repositories, and/or the like. For example, an API may be a standardized software intermediary associated with one or more hardware and/or software components configured to perform one or more functions of the A PI such as receiving and/or providing data (e.g., via requests and/or responses). An A PI may be associated with one or more standards, protocols, definitions, specifications, and/or the like, which define how communications facilitated by the A PI may be performed and/or how the A PI may be configured. An API may serve as a software intermediary enabling data transmissions between components. APIs can connect applications to other applications, applications to servers, and applications and servers to customers or consumers. In general, APIs define how software components interact.

As used herein, the term “user interface” (or “UI”, or “UI widget”) may be used to refer to interactive graphical elements or components used to display information or enable user interaction. Such components can include buttons, checkboxes, dropdown menus, sliders, etc., each serving specific purposes within an application. In general, a user interface refers to a component which provides a visual representation of data.

As used herein, the term “data processor” may be used to refer to a component for data transformation tasks. A data processor's functions span from performing statistical analyses (calculations of mean, median, etc., for example) to generating derivative datasets. Furthermore, a data processor may include advanced capabilities such as machine learning-driven interpolations and fundamental data manipulation operations including formatting adjustments, duplication, deduplication, and zero-padding. The data processor's core purpose is to process incoming data based on predefined algorithms or rules, thereby generating transformed datasets tailored for subsequent stages of analysis, visualization, or storage within a system.

As used herein, the term “local fraud detection model” (or “lightweight fraud detection model,” “lightweight machine learning model,” and the like) may be used to refer to a machine learning model configured for execution using resources available via a web browser or a mobile device hosting a subject application. Local fraud detection models as described herein may be configured using techniques such as model pruning or quantization. Local fraud detection models may refer to pre-trained smaller models, such as TensorFlow Lite or ONNX models, to ensure efficiency without sacrificing accuracy. In at least some embodiments, the local fraud detection model may further comprise an ensemble of lightweight constituent models, such as shallow decision trees, logistic regression models, or low parameters networks. Such ensemble configurations are optimized for execution in low latency environments while maintaining detection accuracy through diverse fraud pattern recognition.

As used herein, the term “variance metric” may be used to refer to a degree of variance between a first feature and a second feature. In at least some embodiments, a variance metric refers to a percentage or ratio by which two extracted features differ relative to one of the features. A variance metric may be determined on a defined scale (e.g., a percentage from 0-100, a defined scale of expected metrics or values, and the like).

As used herein, the term “fraudulent risk score” may be used to refer to a score indicating a predicted likelihood that a subject transaction is fraudulent. A fraudulent risk score may be determined according to one or more transaction features. In such cases, the fraudulent risk score may be determined based on a variance metric comparing one or more transaction features of a subject transaction and one or more baseline transaction pattern object features.

As used herein, the term “baseline transaction pattern object feature” may be used to refer to an extracted feature value associated with a feature of a transaction attempt and/or corresponding transaction attempt data. A baseline transaction pattern object feature may be determined according to a set of historical user transactions. In at least some embodiments, a baseline transaction pattern object feature is an average or a mode value associated with the subject extracted feature.

As used herein, the term “user profile” may be used to refer to a dataset describing a set of “normal” or “expected” values corresponding to any number of extracted features associated with a legitimate transaction. A user profile may be a dataset including indications of (i) one or more subject features or feature labels, and (ii) for each subject feature, an expected value (or a range of expected values) for the subject feature. Expected values may be accepted values which fall within a predetermined acceptable range of an average/mean value for an extracted feature.

As used herein, the term “platform” may be used to generally refer to any application, web browser, software, program, or the like via which a user can interact with transaction services. A platform as used herein may be any application via which a user can initiate a transaction requiring fraud analysis.

### Example System Architecture

Embodiments of the present disclosure may be implemented in various ways, including as computer program products that comprise articles of manufacture, as hardware, including circuitry, configured to perform one or more functions, and/or as combinations of specific hardware and computer program products. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together, such as in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In some embodiments, a non-volatile computer-readable storage medium may include a floppy disk, flexible disk, hard disk, solid-state storage (SSS) (e.g., a solid-state drive (SSD), solid state card (SSC), solid state module (SSM) , enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM) , erasable programmable read-only memory (EPROM) , electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM) , phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, a volatile computer-readable storage medium may include random access memory (RAM), dynamic random access memory (DRAM), static random access memory (SRAM) , fast page mode dynamic random access memory (FPM DRAM), extended data-out dynamic random access memory (EDO DRAM), synchronous dynamic random access memory (SDRAM) , double data rate synchronous dynamic random access memory (DDR SDRAM), double data rate type two synchronous dynamic random access memory (DDR2 SDRAM) , double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM) , Rambus in-line memory module (RIMM) , dual in-line memory module (DIMM) , single in-line memory module (SIMM) , video random access memory (VRAM) , cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may be implemented as one or more methods, apparatuses, systems, computing devices (e.g., client devices, servers, etc.), computing entities, and/or the like. As such, embodiments of the present disclosure may take the form of an apparatus, system, computing device, computing entity, and/or the like executing instructions stored on one or more computer-readable storage mediums (e.g., via the aforementioned software components and computer program products) to perform certain steps or operations. Thus, embodiments of the present disclosure may also take the form of an entirely hardware embodiment, an entirely computer program product embodiment, and/or an embodiment that comprises combination of computer program products and hardware performing certain steps or operations.

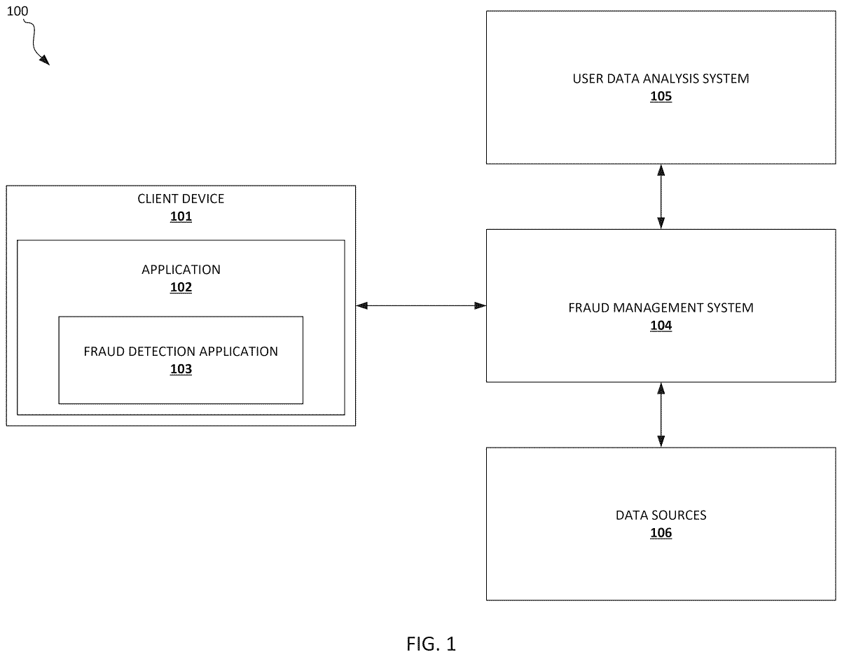

Embodiments of the present disclosure are described below with reference to block diagrams, flowchart illustrations, and other example visualizations. It should be understood that each block of the block diagrams and flowchart illustrations may be implemented in the form of a computer program product, an entirely hardware embodiment, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. In embodiments in which specific hardware is described, it is understood that such specific hardware is one example embodiment and may work in conjunction with one or more apparatuses or as a single apparatus or combination of a smaller number of apparatuses consistent with the foregoing according to the various examples described herein. Accordingly, the block diagrams and flowchart illustrations support various combinations of embodiments for performing the specified instructions, operations, or steps. An example system that can be used according to examples herein is described in FIG. 1.

FIG. 1 illustrates a fraud detection system 100 configured in accordance with at least some example embodiments of the present disclosure. As depicted, fraud detection system 100 includes a client device 101, a fraud management system 104, a user data analysis system 105, and data sources 106. Fraud detection system 100 corresponds to one example arrangement of a system configured for local real-time AI fraud detection and prevention in accordance with the techniques as described herein.

Client device 101 is a device or hardware implementation that a user can use to interact with data, applications (such as application 102 and/or fraud detection application 103), and/or a network. Examples of client device 101 include, but are not limited to, a cell phone, smartphone, tablet, personal computer, laptop, or the like. In general, client device 101 may be any device via which a user can access an application 102 to attempt, access, or otherwise interact with transactional data/attempts.

Application 102 may be a digital application configured to allow a user to access and manage their bank account(s) and financial service(s) remotely. In at least some embodiments, application 102 is a software implementation enabling features such as account management, fund transfers, bill payments, and the like, without requiring a user to physically visit an associated financial institution. In at least some embodiments, application 102 is a web browser application. In such embodiments, application 102 can be a software program or application that allows a user to access and view web pages. Such an application 102 may enable a user to access and manage their account(s) and financial service(s) via a corresponding institution's webpage, rather than via a dedicated mobile application specific to the institution, for example.

Client device 101 may additionally include a user interface application (not pictured) via which the user can interact with application 102, for example. Such a user interface application can include interactive graphical elements or components used to display data as provided by application 102 and/or fraud detection application 103, for example. In some embodiments, such a UI application is configured to provide one or more interactive elements via which a user can interact with the displayed data. In general, such a UI application may be configured to provide a visual representation of the data as provided by application 102 and/or fraud detection application 103. Such a UI application can be configured to be used, rendered, or downloaded to a user or client device.

Fraud detection application 103 may include an AI-driven client-side fraud detection and prevention system integrated directly into a digital banking application/interface such as application 102. In at least some embodiments, fraud detection application 103 includes one or more lightweight machine learning models configured for analyzing transaction activity. Fraud detection application 103 may additionally be configured to provide detected suspicious activity information corresponding to one or more transactions detected as potentially fraudulent to a corresponding fraud detection server (such as fraud management system 104, for example) for further action. In at least some embodiments, fraud detection application 103 is configured to execute one or more remediation actions responsive to detecting a potentially fraudulent transaction/transaction attempt. In at least some embodiments, fraud detection application 103 is configured to lock a user out of application 102 responsive to detecting a potentially fraudulent transaction attempt. Fraud detection application 103 may be configured to trigger a multi factor authentication mechanism responsive to detecting a potentially fraudulent transaction attempt. In at least some embodiments, fraud detection application 103 is a frontend AI module configured to operate on application 102, providing real-time analysis of user interactions and transactions. Fraud detection application 103 may be configured to profile user transaction patterns over time based on a user's interactions with application 102. In at least some embodiments, fraud detection application 103 creates baseline profiles for individual user transaction patterns specific to mobile and online applications such as application 102. Fraud detection application 103 may be configured to continuously adapt the user profile to evolving user interaction patterns. In embodiments wherein user profile information is managed, created, and otherwise updated by user data analysis system 105, fraud detection application 103 may simply receive user profile information from said user data analysis system 105.

In at least some embodiments, fraud detection application 103 is configured for anomaly detection and risk scoring with respect to application 102. Fraud detection application 103 may be configured to compare real-time actions taken with respect to application 102 to established user profile information. In at least some embodiments, fraud detection application 103 is configured to assign a risk score to an analyzed transaction based on the resultant analysis indicating a likelihood that the analyzed transaction is potentially fraudulent. In at least some embodiments, fraud detection application 103 is configured to trigger an MFA mechanism responsive to a determined risk score exceeding a defined threshold. Fraud detection application may be configured to block an analyzed action/interaction/transaction and one/or one or more additional actions responsive to the determined risk score exceeding a defined threshold.

In general, fraud detection application 103 is configured for any of (i) analyzing user activity with respect to application 102, (ii) identifying potentially fraudulent transactions/user activity using one or more lightweight machine learning models, (iii) transmitting potentially fraudulent activity information to a fraud management system 104, and/or (iv) triggering remediation actions, if necessary.

Fraud management system 104 may be configured to manage a plurality of client devices accessing a transaction management system via a plurality of instances of a mobile application and/or a browser interface (such as application 102). Fraud management system 104 may further be configured to communicate with a plurality of instances of fraud detection application 103 corresponding to a plurality of client devices. In at least some embodiments, fraud management system 104 is configured to implement a federated learning framework with respect to fraud detection as informed by the instances of the fraud detection application 103.

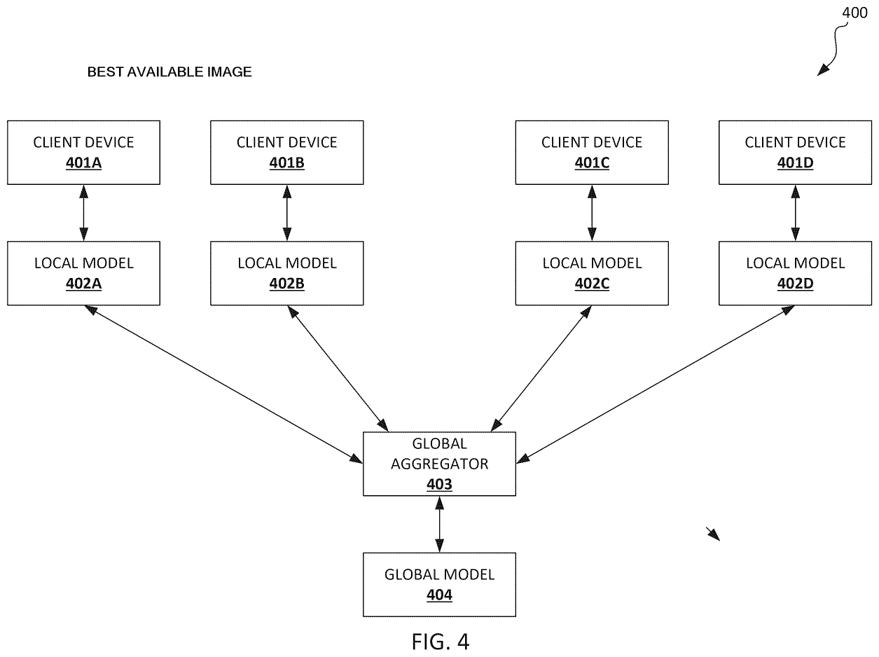

One example of an appropriate federated learning framework is described in further detail with respect to FIG. 4. As depicted, fraud management system 104 is additionally configured to communicate with user data analysis system 105 and data sources 106.

In at least some embodiments, fraud management system 104 is configured for device and location verification. Fraud management system 104 may include authentication mechanisms configured to verify the legitimacy of a client device (such as client device 101) and monitor consistency of login locations. In at least some embodiments, fraud management system 104 executes one or more remediation actions (such as locking an account, denying an access attempt, freezing an account asset, mandating a password change, and the like) responsive to detecting a threshold number of login location/device discrepancies.

In at least some embodiments, either of fraud detection application 103 and/or fraud management system 104 includes an anomaly detection algorithm configured to identify deviations from normal user transaction patterns. Such an anomaly detection algorithm (or machine learning model) may be configured to monitor transaction amounts, login locations, device changes, or any other features associated with fraudulent activity, and flag any corresponding anomalies in real time.

User data analysis system 105 may be configured to analyze user data associated with a user accessing client device 101, application 102, and/or fraud detection application 103. In at least some embodiments, user data analysis system 105 is configured to analyze user data associated with a user of client device 101 and/or application 102 to profile user interaction patterns over time based on a user's interactions with application 102. In at least some embodiments, user data analysis system 105 creates baseline profiles for individual user interaction patterns specific to mobile and online applications such as application 102. User data analysis system 105 may be configured to continuously adapt the user profile to evolving user interaction patterns. Generally, user data analysis system 105 provides a layer of security by providing user profile data without exposing the complete set of user data. In embodiments wherein fraud detection application 103 is granted full access to user data, user data analysis system 105 may be an unnecessary component and therefore may be excluded from the system. In general, user data analysis system 105 generates user profiles by analyzing historical transaction data and user interactions to establish a baseline for normal transaction patterns and interaction patterns, potentially with respect to both a specific user and a broader user base, and updating the user profiles based on ongoing trends.

Data sources 106 may include branches of a financial institution, bank, or other entity associated with fraud detection application 103 and/or fraud management system 104. Generally, data sources 106 include overseeing entities whose services are available via application 102 and are monitored by fraud detection application 103 and fraud management system 104. In at least some embodiments, data sources 106 are configured to provide fraud management system 104 only with data pertinent for updating learning models associated with fraud management system 104 and fraud detection application 103, such that user data need not be exposed in its entirely to these systems/applications. For example, the data sources 106 may be configured to send statistical representations of aggregated user data (such as an average, standard deviation, mode, etc.) for utilization when tailoring the machine learning models leveraged by either the federated learning framework and/or the machine learning models of the fraud detection application, such that these models can be updated to reflect most recent user data without unnecessarily exposing said user data.

Though not depicted, the components of FIG. 1 may be configured to communicate via a network. The network is a set of devices that facilitate communication from a sender to a destination, such as by implementing communication protocols. Example networks include local area networks, wide area networks, private networks such as an intranet, public networks such as the Internet, or any combination thereof. The network may include any wired or wireless communication network including, for example, a wired or wireless local area network (LAN), personal area network (PAN), metropolitan area network (MAN), wide area network (WAN), or the like, as well as any hardware, software and firmware required to implement it (such as, e.g., network routers, etc.). For example, communications network may include a cellular telephone, an 802.11, 802.16, 802.20, or WiMax network. The network may utilize a variety of networking protocols now available or later developed including, but not limited to Transmission Control Protocol, Internet Protocol, etc.

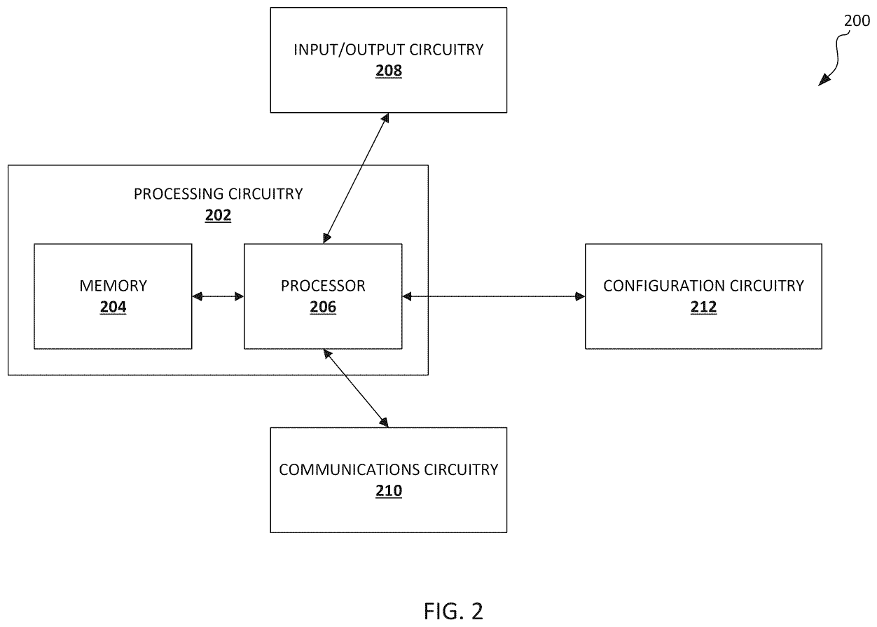

FIG. 2 illustrates a block diagram of an apparatus 200 in accordance with some example embodiments. In some embodiments, the apparatus 200 may include a processing circuitry 202 as shown in FIG. 2. It should be noted, however, that the components, or elements illustrated in and described with respect to FIG. 2 below may not be mandatory and thus one or more may be omitted in certain embodiments. Additionally, some embodiments, may include further or different components or elements beyond those illustrated in and described with respect to FIG. 2. In some embodiments, the apparatus 200 may comprise one or a plurality of physical devices, including distributed, cloud-based, and/or local devices.

Although some components are described with respect to functional limitations, it should be understood that the particular implementations necessarily include the use of particular computing hardware, such as the hardware shown in FIG. 2. It should also be understood that certain of the components described herein may include similar or common hardware. For example, two sets of circuitries for example, may both leverage use of the same processor(s), network interface(s), storage medium(s), and/or the like, to perform their associated functions, such that duplicate hardware is not required for each set of circuitry and a single physical circuitry may be used to perform the functions of multiple circuitries described herein. The use of the term “circuitry” as used herein with respect to components of the apparatuses described herein should therefore be understood to include particular hardware configured to perform the functions associated with the particular circuitry as described herein.

In some embodiments, “circuitry” may include processing circuitry, storage media, network interfaces, input/output devices, and/or the like. In some embodiments, other elements of the apparatus 200 may provide or supplement the functionality of another particular set of circuitry. For example, the processor 206 in some embodiments provides processing functionality to any of the sets of circuitries, the memory 204 provides storage functionality to any of the sets of circuitry, the communications circuitry 210 provide network interface functionality to any of the sets of circuitry, and/or the like.

The apparatus 200 may include or otherwise be in communication with processing circuitry 202 that is configurable to perform actions in accordance with one or more example embodiments disclosed herein. In this regard, the processing circuitry 202 may be configured to perform and/or control performance of one or more functionalities of the apparatus 200 in accordance with various example embodiments, and thus may provide means for performing functionalities of the apparatus 200 in accordance with various example embodiments. The processing circuitry 202 may be configured to perform data processing, application, and function execution, and/or other processing and management services according to one or more example embodiments. In some embodiments, the apparatus 200 or a portion(s) or component(s) thereof, such as the processing circuitry 202, may be embodied as or comprise a chip or chip set. In other words, apparatus 200 or the processing circuitry 202 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 200 or the processing circuitry 202 may therefore, in some cases, be configured to implement an embodiment of the disclosure on a single chip or as a single “system on a chip.” As such, in some cases, a chip or chipset may constitute means for performing one or more operations for providing the functionalities described herein.

In some embodiments, the processing circuitry 202 may include a processor 206 (and/or co-processor or any other processing circuitry assisting or otherwise associated with the processor) and, in some embodiments, such as that illustrated in FIG. 2, may further include memory 204. The processing circuitry 202 may be in communication with or otherwise control a user interface (e.g., embodied by input/output circuitry 208) and/or a communications circuitry 210. As such, the processing circuitry 202 may be embodied as a circuit chip (e.g., an integrated circuit chip) configured (e.g., with hardware, software or a combination of hardware and software) to perform operations described herein.

The processor 206 may be embodied in a number of different ways. For example, the processor 206 may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. Although illustrated as a single processor, it will be appreciated that the processor 206 may comprise a plurality of processors. The plurality of processors may be in operative communication with each other and may be collectively configured to perform one or more functionalities of the apparatus 200 as described herein. In some example embodiments, the processor 206 may be configured to execute instructions stored in the memory 204 or otherwise accessible to the processor 206. As such, whether configured by hardware or by a combination of hardware and software, the processor 206 may represent an entity (e.g., physically embodied in circuitry—in the form of processing circuitry 202) capable of performing operations according to embodiments of the present disclosure while configured accordingly. Thus, for example, when the processor 206 is embodied as an ASIC, FPGA or the like, the processor 206 may be specifically configured hardware for conducting the operations described herein. Alternatively, as another example, when the processor 206 is embodied as an executor of software instructions, the instructions may specifically configure the processor 206 to perform one or more operations described herein. The use of the terms “processor” and “processing circuitry” may be understood to include a single core processor, a multi-core processor, multiple processors internal to the apparatus 200, and/or one or more remote or “cloud” processor(s) external to the apparatus 200.

In some example embodiments, the memory 204 may include one or more non-transitory memory devices such as, for example, volatile and/or non-volatile memory that may be either fixed or removable. In this regard, the memory 204 may comprise a non-transitory computer-readable storage medium. It will be appreciated that while the memory 204 is illustrated as a single memory, the memory 204 may comprise a plurality of memories. The memory 204 may be configured to store information, data, applications, instructions and/or the like for enabling the apparatus 200 to carry out various functions in accordance with one or more example embodiments. For example, the memory 204 may be configured to buffer input data for processing by the processor 206. Additionally, or alternatively, the memory 204 may be configured to store instructions for execution by the processor 206. The memory 204 may include one or more databases that may store a variety of files, contents, or data sets. Among the contents of the memory 204, applications may be stored for execution by the processor 206 in order to carry out the functionality associated with each respective application. In some cases, the memory 204 may be in communication with one or more of the processors 206, input/output circuitry 208, and/or communications circuitry 210, via a bus(es) for passing information among components of the apparatus 200.

The input/output circuitry 208 may provide output to the user or an intermediary device and, in some embodiments, may receive one or more indication(s) of user input. In some embodiments, the input/output circuitry 208 is in communication with processor 206 to provide such functionality. The input/output circuitry 208 may include one or more user interface(s) and/or include a display that may comprise the user interface(s) rendered as a web user interface, an application interface, and/or the like, to the display of a requesting entity, a backend system, or the like. The input/output circuitry 208 may be in communication with the processing circuitry 202 to receive an indication of a user input at the user interface and/or to provide an audible, visual, mechanical, or other output to the user. As such, the input/output circuitry 208 may include, for example, a keyboard, a mouse, a joystick, a display, a touch screen display, a microphone, a speaker, and/or other input/output mechanisms. As such, the input/output circuitry 208 may, in some example embodiments, provide means for a user to access and interact with the apparatus 200. The processor 206 and/or input/output circuitry 208 comprising or otherwise interacting with the processor 206 may be configured to control one or more functions of one or more user interface elements through computer program instructions (e.g., software and/or firmware) stored on a memory accessible to the processor 206 (e.g., stored on memory 204, and/or the like).

The communications circuitry 210 may include one or more interface mechanisms for enabling communication with other devices and/or networks. In some cases, the communications circuitry 210 may be any means such as a device or circuitry embodied in either hardware, or a combination of hardware and software that is configured to receive and/or transmit data from/to a network and/or any other device or module in communication with the processing circuitry 202. The communications circuitry 210 may, for example, include an antenna (or multiple antennas) and supporting hardware and/or software for enabling communications with a wireless communication network (e.g., a wireless local area network, cellular network, global positing system network, and/or the like) and/or a communication modem or other hardware/software for supporting communication via cable, digital subscriber line (DSL), universal serial bus (USB), Ethernet or other methods.

In some embodiments, the apparatus 200 may include a configuration circuitry 212 which may include hardware components, software components, and/or a combination thereof configured to, with the processing circuitry 202, input/output circuitry 208 and/or communications circuitry 210, perform one or more functions associated with the client device 101 (as described above with reference to FIG. 1). For example, the configuration circuitry 212 may access, facilitate access, receive process, manipulate, provide, or otherwise use, or make available for use, data used by one or more other components of the apparatus 200 through, for example, the use of program code executed using a processor, such as the processor 206. In some embodiments, the configuration circuitry 212 may interact with the memory 204, which may store the aforementioned data. It should also be appreciated that, in some embodiments, the configuration circuitry 212 may include a separate processor, specially configured field programmable gate array (FPGA), or application specific interface circuit (ASIC) to provide or otherwise facilitate access to such data used by one or more other components of the apparatus 200. The configuration circuitry 212 may also provide for communication with other components of the apparatus, system and/or external systems via a network interface provided by the communications circuitry 210.

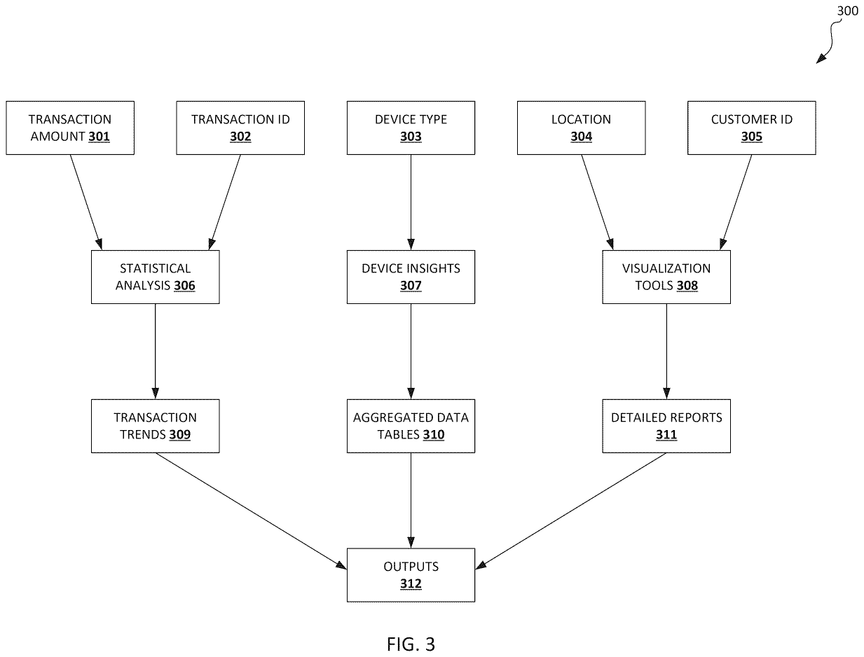

FIG. 3 is a dataflow diagram 300 depicting collected transaction data and corresponding feature engineering processes in accordance with at least one embodiment of the present disclosure. It should be appreciated that the data and features described with respect to dataflow diagram 300 are intended to be illustrative and non-exhaustive, and as such, many modifications (including additions and exclusions) may be appropriate with respect to other embodiments of the present disclosure.

As depicted, dataflow diagram 300 ultimately yields a set of outputs 312. The set of outputs 312 include a set of detailed reports 311, a set of aggregated data tables 310, and a set of transaction trends 309. The set of transaction trends 309 may be determined according to a received set of transaction amounts 301 and a received set of transaction IDs 302. The set of transaction amounts 301 and corresponding set of transaction IDs 302 may include transaction data indicating transactional values and their corresponding transaction IDs, thereby enabling statistical analysis (mean, mode, standard deviations, etc.) across the set of transaction amounts 301. The set of aggregated data tables 310 is determined according to a set of device insights 307 determined according to a set of device type data 303. The set of device type data 303 includes device type (or platform type) indicators associated with a plurality of transactions, such that the transactions can be separated for analysis according to device type. Accordingly, the set of device insights 307 may include one or more indications of transaction trends or fraud trends which differ according to device type. The set of device insights 307 can be used to calibrate a machine learning model according to device type. The set of aggregated data tables 310 includes data tables indicating various feature data associated with the plurality of transactions, such that the pertinent feature data is segmented according to a platform via which the transaction was attempted. The set of detailed reports 311 is provided using a set of visualization tools 308, which analyze a set of location information 304 and a set of customer identification data 305. The set of visualization tools 308 are configured to generate the set of detailed reports 311 which display a visualization of the set of location information 304 and the set of consumer data 305 such that trends associated with location and user ID can be easily viewed and/or identified.

In at least some embodiments, specific models or model features may be selected according to the platform type/execution platform. For example, for a web browser based platform, lightweight Javascript-based models such as those utilizing Tensorflow.js may be comployed to ensure compatibility and performance with the browser environment. For mobile application platforms, on-device models such as TensorFlow or Core ML may be used, thereby incorporating features such as biometrics interaction patterns or device specific location signals to enhance fraud detection accuracy while maintaining efficiency.

FIG. 4 is a dataflow diagram 400 depicting dataflow within a federated learning environment in accordance with at least some example embodiments of the present disclosure. As depicted, dataflow diagram 400 includes a plurality of client devices 401 (401A, 401B, 401C, 401D) each with their own corresponding local model 402 (402A, 402B, 402C, 402D), a global aggregator 403, and a global model 404. Each local model 402 executes according to transactions associated with its corresponding client device 401. Global aggregator 403 is configured to receive data from each local model 402 indicating recently executed transaction analyses and corresponding model updates. Global aggregator 403 is configured to aggregate this information and generate a single set of model updates to be applied to the global model 404. Once such a set of updates is aggregated and applied to global model 404, it is also applied to each of the local models 402, such that all of the implemented models operate based on the most recent and most complete set of information. Global aggregator 403 may be configured to update global model 404 and the local models 402 simultaneously.

### Example Methods

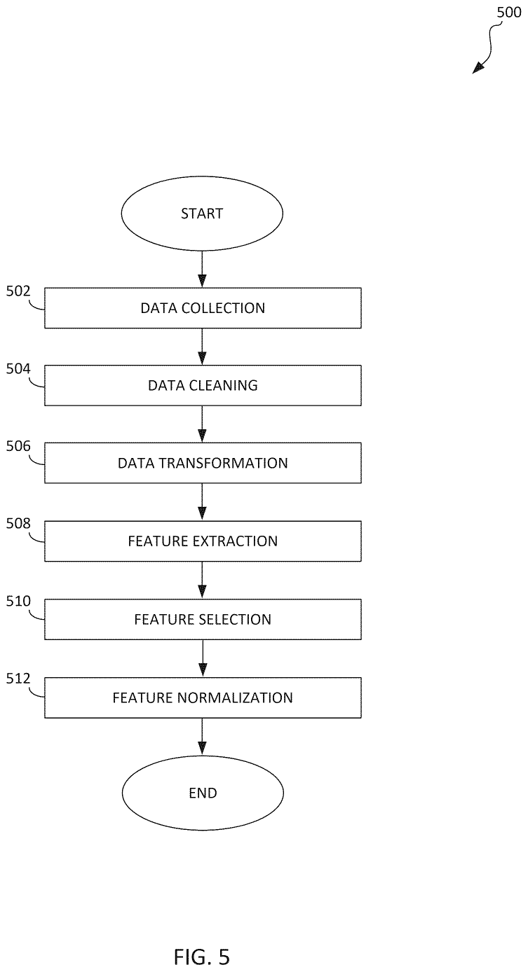

FIG. 5 illustrates a flowchart depicting an example method 500 for preparing data for use with respect to the fraud detection techniques as described herein in accordance with at least one embodiment of the present disclosure. As depicted, the example method 500 may include data collection 502, data cleaning 504, data transformation 506, feature extraction 508, feature selection 510, and feature normalization 512. It should be appreciated that the processes described with respect to FIG. 5 may be executed by fraud detection application 103, fraud management system 104, and/or any devices configured in accordance with fraud detection application 103 or fraud management system 104. The steps below are described as being executed by a “subject application,” which includes a responsible system and/or device where applicable. The steps of example method 500 may be described in aggregate as data preprocessing and feature engineering. It should be appreciated that separate instances of example method 500 may be executed with respect to mobile application practices and web browser practices, such that extracted features and associated risks are determined specific to a corresponding platform to accurately reflect the practices associated with each platform specifically. In at least some embodiments, a single instance of example method 500 is utilized, wherein platform of use is a feature associated with transactions and/or access attempts.

At step 502, the subject application collects a set of data. Data collection 502 includes collecting real-time transactional data from several responsible entities. For example, the subject application may be configured to collect said real-time transactional data from several banking systems associated with a fraud detection application. The collected data may include fundamental aspects of the transaction such as transaction value(s), user(s), geographical location(s), time(s), and history of the transactions. In at least some embodiments, the data may be collected in a secure format thereby ensuring user privacy and security.

At step 504, the subject application cleans the collected set of data. Data cleaning 504 includes identifying and correcting errors, inconsistencies, and inaccuracies in the collected dataset to improve its quality and usability for analysis. Data cleaning 504 may also be referred to as data cleansing and/or data scrubbing. In at least some embodiments, data cleaning 504 includes identifying one or more missing values/data items and deciding whether to impute such missing values or remove them entirely. In at least some embodiments, data cleaning 504 includes identifying and correcting inconsistencies in data formats, spellings, or values associated with various data entries. Data cleaning 504 may include removing duplicate records to avoid overcounting or skewed results. In at least some embodiments, data cleaning 504 includes determining whether any outliers are genuine data points or errors, and subsequently deciding whether to remove or transform them based on the determination. Data cleaning 504 may include remedying detected typographical errors.

At step 506, the subject application transforms the set of collected data. Data transformation 506 may include converting the collected (and cleaned) data from a first format to a second format. In some embodiments, data transformation 506 includes converting the collected data from a raw data source format into a standardized format usable with respect to one or more machine learning models leveraged by machine learning models of the corresponding fraud detection application/fraud management system. Data transformation 506 may include constructive data transformation, by which data is added, copied, or replicated with respect to the collected data. In at least some embodiments, data transformation 506 includes destructive data transformation, by which fields or records of the collected data are deleted. Data transformation 506 may include aesthetic data transformation, by which the data is standardized to meet requirements or parameters associated with the aforementioned machine learning models, for example. In at least some embodiments, data transformation 506 includes structural data transformation, by which the collected data is reorganized by renaming, moving, or combining columns.

At step 508, the subject application extracts features from the collected data. Feature extraction 508 may include identifying and extracting relevant features from the transformed data to create a more informative dataset for tasks such as classification, prediction, and clustering. In at least some embodiments, feature extraction 508 includes transforming the collected data into a format processable by the aforementioned machine learning models. Feature extraction provides improved model efficiency, accuracy, and reduced computational costs by identifying the most important information, or features. In at least some embodiments, feature extraction 508 includes leveraging natural language processing (NLP) with respect to the collected transaction data to extract words and phrases from any corresponding textual data which may indicate important keywords associated with the subject transaction, for example. Feature extraction 508 may include leveraging image processing techniques to extract information from any images provided relative to a transaction, such as a scanned copy of a check associated with a transaction. In such embodiments, image processing techniques may be used to extract pertinent transaction data from such an image. In general, feature extraction 508 includes extracting a set of features from the collected data.

At step 510, the subject application selects features from the extracted features. Feature selection 510 may include identifying and selecting a subset of relevant features from the extracted set of features to improve model performance, reduce overfitting, and enhance interpretability. In at least some embodiments, feature selection 510 includes determining a most informative subset of the extracted features based at least in part on historical transaction analysis data. Feature selection 510 may include selecting a subset of the extracted features based at least in part on a set of features/feature labels configured and pre-defined by an administrator. In at least some embodiments, feature selection 510 includes identifying features in historical dataset which were most heavily correlated with fraudulent transactions, such as spending pattern, frequency of transactions, or geographical location.

At step 512, the subject application normalizes the selected features. Feature normalization 512 may include rescaling the range of the features (independent variables) to a specific range, often between 0 and 1. In at least some embodiments, feature normalization 512 includes selecting a scale to improve performance and stability of machine learning models.

Feature normalization 512 helps mitigate the impact of outliers and ensures that all features contribute equally to a subject model, thereby preventing features with larger values from dominating the learning process of the subject model. In at least some embodiments, feature normalization 512 includes leveraging min-max scaling techniques to scale the features to a range between 0 and 1, or −1 and 1, by using the minimum and maximum values of each feature. In at least some embodiments, feature normalization 512 leverages feature standardization techniques (such as Z-score normalization) to transform the data to have a mean of 0 and a standard deviation of 1. In at least some embodiments, feature normalization 512 may include leveraging robust scaling techniques to transform the data to have a defined median and interquartile range (IQR).

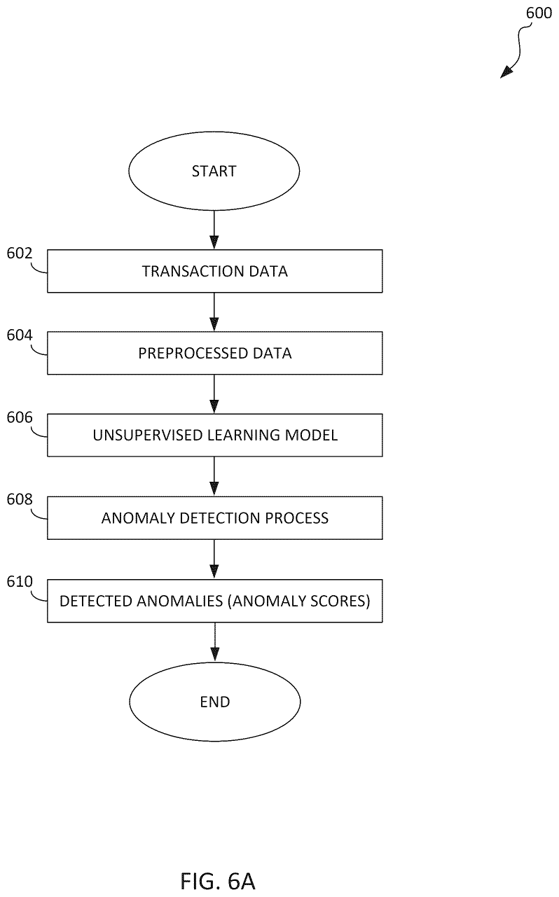

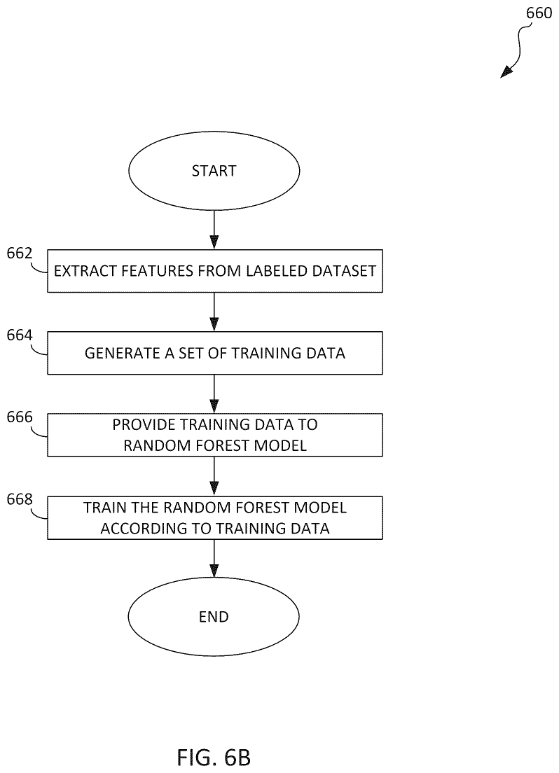

FIG. 6A illustrates a flowchart depicting an example method 600 for supervised learning model training with respect to the fraud detection techniques as described herein in accordance with at least one embodiment of the present disclosure. As depicted, the example method 600 includes preprocessing (602) a set of transaction data, extracting (604) a set of features from the set of transaction data, providing (606) the processed data and features to an unsupervised learning model, and determining (608) a set of anomaly scores associated with the unsupervised learning model output. Example method 600 generally enables identification of new, unknown fraud types that deviate from normal user transaction patterns and user interaction patterns. It should be appreciated that separate instances of example method 600 may be executed with respect to mobile application practices and web browser practices, such that extracted features and associated risks are determined specific to a corresponding platform to accurately reflect the practices associated with each platform specifically. In at least some embodiments, a single instance of example method 600 is utilized, wherein platform of use is a feature associated with transactions and/or access attempts.

At step 602, a subject application preprocesses a set of transaction data. Preprocessing (602) a set of transaction data may include collecting and cleaning a dataset associated with a plurality of transactions. In at least some embodiments, preprocessing (602) a set of transaction data includes transforming the set of transaction data into a format usable by an unsupervised learning model. Examples of data preprocessing steps/techniques are described in detail with respect to steps 502, 504, and 506 of example method 500 described with respect to FIG. 5.

At step 604, the subject application is configured to extract a set of features from the set of transaction Extracting (604) a set of features from the set of transaction data may include identifying and extracting relevant features from the transformed data to create a more informative dataset for tasks such as classification, prediction, and clustering. In at least some embodiments, extracting (604) a set of features includes transforming the set of transaction data into a format processable by one or more machine learning models. In at least some embodiments, extracting (604) a set of features includes leveraging natural language processing (NLP) with respect to the collected transaction data to extract words and phrases from any corresponding textual data which may indicate important keywords associated with the subject transaction, for example. Extracting (604) a set of features may include leveraging image processing techniques to extract information from any images provided relative to a transaction, such as a scanned copy of a check associated with a transaction. In such embodiments, image processing techniques may be used to extract pertinent transaction data from such an image.

In at least some embodiments, extracting (604) a set of features may include identifying and selecting a subset of relevant features from the extracted set of features to improve model performance, reduce overfitting, and enhance interpretability. In at least some embodiments, extracting (604) a set of features includes determining a most informative subset of the extracted features based at least in part on historical transaction analysis data. Extracting (604) a set of features may include selecting a subset of the extracted features based at least in part on a set of features/feature labels configured and pre-defined by an administrator. In at least some embodiments, extracting (604) a set of features includes identifying features in historical dataset which were most heavily correlated with fraudulent transactions, such as spending pattern, frequency of transactions, or geographical location. In at least some embodiments, feature extraction is limited to extracting features which have been identified as particularly relevant or otherwise significant when detecting fraud. In at least some embodiments, significant features as described herein refer to features which have a strong correlation to fraudulent transactions, or a strong correlation to legitimate transactions, based at least in part on feature analysis with respect to historical transactions.

In at least some embodiments, extracting (604) a set of features includes normalizing the selected features. Feature normalization may include rescaling the range of the features (independent variables) to a specific range, often between 0 and 1. In at least some embodiments, extracting (604) a set of features includes selecting a scale to improve performance and stability of machine learning models. In at least some embodiments, extracting (604) a set of features includes leveraging min-max scaling techniques to scale the features to a range between 0 and 1, or −1 and 1, by using the minimum and maximum values of each feature. In at least some embodiments, extracting (604) a set of features includes leveraging feature standardization techniques (such as Z-score normalization) to transform the data to have a mean of 0 and a standard deviation of 1. In at least some embodiments, extracting (604) a set of features may include leveraging robust scaling techniques to transform the data to have a defined median and interquartile range (IQR).

At step 606, the subject application provides the processed data and features to an unsupervised learning model. Providing (606) the processed data and features to an unsupervised learning model may include transmitting the training data to an entity responsible for hosting the unsupervised learning model, such as fraud detection application 103 or fraud management system 104. In at least some embodiments, providing (666) the training data to the unsupervised learning model includes making the training data available to a defined set of entities via a datastore accessible to said set of entities.

At step 608, the subject application determines a set of anomaly scores associated with the unsupervised learning model output. Determining (608) a set of anomaly scores associated with the unsupervised learning model output may include leveraging one or more anomaly detection models with respect to the unsupervised learning model output to identify variations in transaction patterns as indicated by the output. In at least some embodiments, determining (608) a set of anomaly scores includes leveraging isolation forests to analyze and quantify anomalies with respect to the unsupervised learning model output. In at least some embodiments, determining (608) a set of anomaly scores includes leveraging an autoencoder to identify variations in transaction patterns.

FIG. 6B illustrates a flowchart depicting an example method 660 for supervised learning model training with respect to the fraud detection techniques as described herein in accordance with at least one embodiment of the present disclosure. As depicted, the example method 660 includes extracting (662) features from a labeled dataset, generating (664) training data, providing (666) the training data to a random forest model, and training (668) the random forest model based on the training data. While example method 660 is described with respect to a random forest model, it should be appreciated that the supervised training techniques described with respect to method 660 may additionally be leveraged with respect to any number of machine learning models. In general, example method 660 is configured to train machine learning models based on insights from real-world transaction information. It should be appreciated that separate instances of example method 660 may be executed with respect to mobile application practices and web browser practices, such that extracted features and associated risks are determined specific to a corresponding platform to accurately reflect the practices associated with each platform specifically. In at least some embodiments, a single instance of example method 660 is utilized, wherein platform of use is a feature associated with transactions and/or access attempts.

At step 662, a subject application extracts features from a labeled dataset. Extracting (662) features from a labeled dataset may include identifying and extracting relevant features from the labeled dataset to create a more informative dataset for tasks such as classification, prediction, and clustering. In at least some embodiments, extracting (662) features from the labeled dataset includes transforming the data into a format processable by the aforementioned machine learning models. In at least some embodiments, extracting (662) features from the labeled dataset includes leveraging natural language processing (NLP) with respect to the collected transaction data to extract words and phrases from any corresponding textual data which may indicate important keywords associated with the subject transaction, for example.

At step 664, the subject application generates training data. Generating (664) training data may include generating a set of data including the labeled dataset and a set of features associated with the labeled dataset such that the subject machine learning model can analyze and otherwise detect correlations between the set of features and the labeled dataset. In at least some embodiments, the labeled dataset indicates whether a transaction has been labeled as fraudulent or legitimate. As such, generating (664) training data may include structuring the labeled dataset and the corresponding features in a format/structure that is interpretable by any subject machine learning models.

At step 666, the subject application is configured to provide the training data to a random forest model. Providing (666) the training data to a random forest model may include transmitting the training data to an entity responsible for hosting the subject random forest model, such as fraud detection application 103 or fraud management system 104. In at least some embodiments, providing (666) the training data to a random forest model includes making the training data available to a defined set of entities via a datastore accessible to said set of entities.

At step 668, the subject application is configured to train the random forest model. Training (668) the random forest model based on the training data may include leveraging the random forest model to identify associations between the features of the transactions of the data set and the labels associated with said features. In at least some embodiments, training (668) the random forest model based on the training data includes using the random forest model to identify one or more correlations between the labeled transactions and one or more features of said transactions.

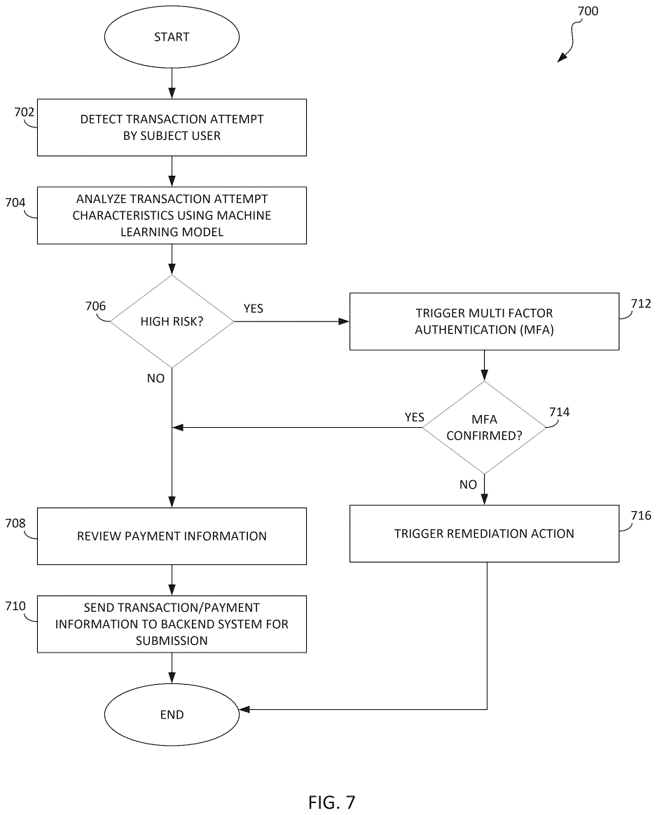

FIG. 7 illustrates a flowchart depicting an example method 700 for fraud detection in accordance with at least one embodiment of the present disclosure. As depicted, example method 700 includes detecting (702) a transaction attempt by a subject user, analyzing (704) the transaction attempt characteristics, determining (706) whether the transaction is a high risk transaction, reviewing (708) payment information, sending (710) transaction information to a backend system, triggering (712) multifactor authentication (MFA), determining (714) whether the MFA was confirmed, and triggering (716) a remediation action. In general, example method 700 provides a transaction management method executable by a fraud detection application, such as fraud detection application 103.

At step 702, fraud detection application 103 detects a transaction attempt by a subject user. In at least some embodiments, detecting (702) a transaction attempt by a subject user includes detecting a user access attempt with respect to an application (such as application 102) monitored and/or managed by fraud detection application 103. In at least some embodiments, detecting (702) a transaction attempt by a subject user includes detecting a user attempt to execute a transaction within application 102. In general, detecting (702) a transaction attempt includes monitoring an application for user activity and identifying an attempt to execute a transaction associated with the application.

At step 704, fraud detection application 103 analyzes the transaction attempt characteristics. Analyzing (704) the transaction attempt characteristics may include inputting metadata associated with the transaction attempt to a machine learning model. In at least some embodiments, the machine learning model is an unsupervised learning model, such as the unsupervised learning model trained and described with respect to FIG. 6A. In at least some embodiments, the machine learning model is a supervised learning model, such as the supervised learning model trained and described with respect to FIG. 6B. In general, analyzing (704) the transaction attempt characteristics includes analyzing one or more features of the transaction attempt which are determined to strongly correlate with fraudulent transactions, and determining whether said features indicate a potentially fraudulent transaction. In at least some embodiments, analyzing (704) the transaction attempt characteristics includes characterizing the transaction as high risk or low risk based on the analysis of the aforementioned features. In at least some embodiments, analyzing (704) the transaction attempt characteristics includes associating a risk score with the transaction based on the analyzed characteristics. A subset of pertinent transaction characteristics may include, but is not limited to, login locations, transaction amounts, transaction frequency, transaction locations, and the like.

At step 706, fraud detection application 103 determines whether the transaction is a high-risk transaction. Determining (706) whether the transaction is a high-risk transaction may include comparing a transaction score associated with the transaction to a threshold transaction. If the transaction is indeed a high-risk transaction (706, yes branch), the method continues to trigger (712) a multifactor authentication mechanism. If the transaction is not a high-risk transaction (706, no branch), the method continues by reviewing (708) payment information associated with the transaction.

At step 708, fraud detection application 103 reviews payment information associated with the transaction. Reviewing (708) payment information associated with the transaction may include verifying payment information associated with the transaction attempt for accuracy, completeness, and validity. For example, reviewing (708) payment information associated with the transaction may include verifying that adequate funds are available via an indicated payment account to complete the transaction. In general, reviewing (708) payment information associated with the transaction includes verifying that the indicated payment information is adequate for completing the transaction.

At step 710, fraud detection application 103 sends transaction information to a backend system. Sending (710) transaction information to the backend system may include transmitting the transaction information and the payment information to a backend system such that the attempted transaction may be completed. In at least some embodiments, such as those where fraud detection application 103 is authorized to send payments directly to a vendor or other external party/application, fraud detection application 103 may bypass the backend application and provide payment information directly to a desired party.

At step 712, fraud detection application 103 triggers an MFA mechanism. Triggering (712) an MFA mechanism may include leveraging a third-party application for authenticating a user's transaction attempt or access attempt. In at least some embodiments, triggering (712) an MFA mechanism includes sending a message to a user's personal device (such as a cell phone) via text message, phone call, or email, said message comprising a code the user must enter to verify account activity. In at least some embodiments, triggering (712) an MFA mechanism includes prompting a user to verify their identity using a third-party authentication application or service.

At step 714, fraud detection application 103 determines whether the MFA was confirmed. Determining (714) whether the MFA was confirmed may include analyzing any received response associated with the MFA mechanism to determine its validity. If the received MFA response is indeed valid (714, yes branch), the method continues to review (708) payment information. If the received MFA response is deemed invalid, or if no MFA response is received within an established timeframe (714, no branch), the method continues to trigger (716) a remediation action.

At step 716, fraud detection application 103 is configured to trigger a remediation action. Triggering (716) a remediation action may include, but is not limited to, locking the user account, blocking the transaction attempt, sending an alert indicating a potentially fraudulent transaction to any of a user contact, a backend system, an additional party associated with the transaction and the like. In general, triggering (716) a remediation action includes preventing the analyzed transaction from being completed responsive to an inability to verify the transaction's legitimacy.

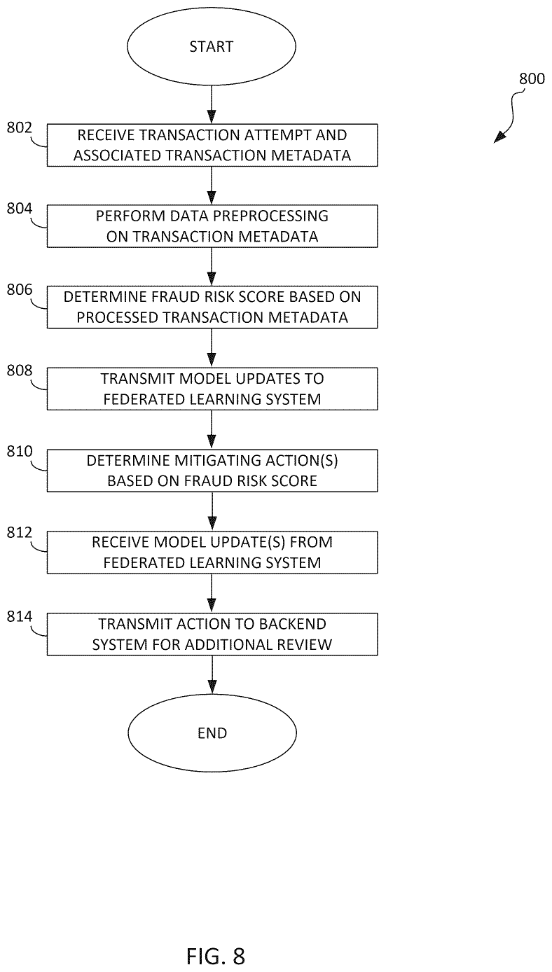

FIG. 8 illustrates a flowchart depicting an example method 800 for fraud detection in accordance with at least one embodiment of the present disclosure. As depicted, example method 800 includes receiving (802) a transaction attempt and associated transaction metadata, performing (804) data preprocessing on the transaction metadata, determining (806) a fraud risk score based on the processed transaction metadata, transmitting (808) model updates to a federated learning system, determining (810) mitigating action(s) based on the fraud risk score, receiving (812) model update(s) from the federated learning system, and transmitting (814) the mitigating action(s) to a backend system. Example method 800 may enable fraud detection and corresponding machine learning model updates in a federated learning environment.

At step 802, fraud detection application 103 receives a transaction attempt and associated transaction metadata. Receiving (802) a transaction attempt and associated transaction metadata may include detecting a user access attempt with respect to an application (such as application 102) monitored and/or managed by fraud detection application 103. In at least some embodiments, receiving a transaction attempt and associated transaction metadata includes detecting a user attempt to execute a transaction within application 102. Receiving a transaction attempt and associated transaction metadata may include monitoring an application for user activity and identifying an attempt to execute a transaction associated with the application. In general, receiving (802) a transaction attempt and associated transaction metadata includes detecting a transaction attempted via a monitored/managed application (such as an application hosting/containing fraud detection application 103) and identifying associated transaction metadata.

At step 804, fraud detection application 103 performs data preprocessing on the transaction metadata. Performing (804) data preprocessing on the transaction metadata may include executing any of data collection, data cleaning, data transformation, feature extraction, feature selection, and/or feature normalization with respect to the transaction metadata.

Appropriate preprocessing steps/mechanisms are described in further detail with respect to example method 500 of FIG. 5.

At step 806, fraud detection application 103 determines a fraud risk score based on the processed transaction metadata. Determining (806) a fraud risk score based on the processed transaction metadata may include inputting metadata associated with the transaction attempt to a machine learning model. In at least some embodiments, the machine learning model is an unsupervised learning model, such as the unsupervised learning model trained and described with respect to FIG. 6A. In at least some embodiments, the machine learning model is a supervised learning model, such as the supervised learning model trained and described with respect to FIG. 6B. In general, generating (806) a fraud risk score based on the processed transaction metadata includes analyzing one or more features of the transaction metadata which are determined to strongly correlate with fraudulent transactions, and determining whether said features indicate a potentially fraudulent transaction. In at least some embodiments, determining (806) a fraud risk score based on the processed transaction metadata includes characterizing the transaction as high risk or low risk based on the analysis of the aforementioned features. In at least some embodiments, determining (806) a fraud risk score based on the processed transaction metadata includes associating a risk score with the transaction based on a subset of pertinent transaction characteristics that may include, but is not limited to, login locations, transaction amounts, transaction frequency, transaction locations, and the like.

In at least some embodiments, generating (806) a fraud risk score includes, for a subject transaction feature of the one or more transaction object features, determining a set of variance metrics for the subject transaction feature. The set of variance metrics may include one or more metrics each defining a degree of variance between the subject transaction feature and a corresponding baseline transaction pattern object feature of a user profile. In at least some embodiments, the user profile includes a plurality of baseline transaction pattern object features indicating acceptable values or acceptable value ranges corresponding to one or more features determined to correlate strongly to fraudulent transactions. Generating (806) a fraud risk score may include aggregating a plurality of sets of feature variance metrics associated with one or more transaction object features.

At step 808, fraud detection application 103 transmits model updates to a federated learning system. In at least some embodiments, transmitting (808) model updates to a federated learning system includes transmitting a subset of the transaction metadata and a fraud risk score associated with the transaction to a system (such as fraud management system 104) responsible for federated learning in a fraud prevention framework. Such a subset of the transaction metadata may include data associated with features which are determined to be correlated with accurately identifying fraudulent activity. In at least some embodiments, transmitting (808) model updates to a federated learning system includes obscuring, masking, or otherwise excluding any personal identifying information corresponding to the user. In general, transmitting (808) model updates includes notifying the federated learning system of the determined fraud risk score and corresponding transaction characteristics associated with the fraud risk score.

At step 810, fraud detection application 103 determines mitigating actions based on the fraud risk score. Determining (810) mitigating action(s) based on the fraud risk score may include determining whether any mitigating actions are required. In at least some embodiments, mitigating action(s) may be required if the fraud risk score exceeds a defined threshold. In at least some embodiments, two fraud risk score thresholds may exist: a first threshold indicating a risk score at which a multifactor authentication mechanism is triggered, and a second threshold at which additional mitigating action may be required. Responsive to determining that the fraud risk score exceeds a first threshold, fraud detection application 103 triggers an MFA mechanism, via which a user can validate their transaction attempt. If the MFA mechanism is satisfied, the transaction may be determined as valid (not fraudulent). If the MFA mechanism is not satisfied, the transaction is treated as though the second threshold is failed. Responsive to determining that the fraud risk score exceeds the second threshold, or an MFA mechanism is not satisfied, fraud detection application 103 triggers one or more additional mitigating actions. A mitigating action may include, but is not limited to, locking the user account, blocking the transaction attempt, sending an alert indicating a potentially fraudulent transaction to any of a user contact, a backend system, an additional party associated with the transaction and the like. In general, a mitigating action includes is configured to prevent the analyzed transaction from being completed responsive to an inability to verify the transaction's legitimacy.

At step 812, fraud detection application 103 receives model updates from the federated learning system. Receiving (812) model update(s) from the federated learning system may include receiving updates to one or more machine learning model parameters from the federated learning system. The federated learning system is configured to continuously learn/retrain based on ongoing transactional data associated with transaction attempts made via additional instances of mobile applications and/or browser accesses associated with fraud management system 104. As such, various parameters of the machine learning model(s) utilized by fraud management system 104 and fraud detection application 103 may be adjusted according to updated transaction data.

At step 814, fraud detection application 103 transmits the determined mitigating action(s) to a backend system. Transmitting (814) the mitigating action(s) to a backend system may include transmitting an indication of the determined required mitigating actions. In at least some embodiments, such as those where fraud detection application 103 is authorized to execute mitigating actions without oversight, transmitting (814) may include simply transmitting an indication of the mitigating actions taken, or may be omitted entirely. In at least some embodiments, such as those where mitigating actions must be taken by the backend system (such as fraud management system 104), transmitting (814) the mitigating action(s) to a backend system includes alerting the backend system of (i) the detected high risk transaction, (ii) the associated user account requiring mitigating action, and (iii) the determined/suggested mitigating action.

In at least some embodiments, either or both of example method 700 and example method 800 may further include configuring a local fraud detection model based on historical transaction data. In at least some embodiments, the historical transaction data includes a historical transaction dataset corresponding to historical transactions associated with a plurality of users. In at least some embodiments, the historical transaction dataset includes data from transactions executed via a subject platform (e.g., a web browser platform or a mobile application). The historical transaction data may include a historical user transaction dataset comprising a plurality of historical transactions initiated by the user and ultimately completed or allowed/authorized. In at least some embodiments, the local fraud detection model is a lightweight machine learning model optimized for execution by a client device hosting an application.

### Example Computing Environment

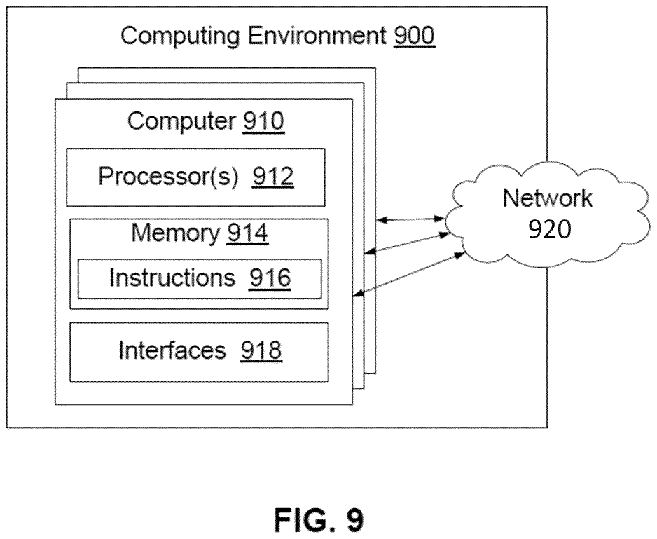

FIG. 9 discloses a computing environment 900 in which aspects of the present disclosure may be implemented. A computing environment 900 is a set of one or more virtual or physical computers 910 that individually or in cooperation achieve tasks, such as implementing one or more aspects described herein. The computers 910 have components that cooperate to cause output based on input. Example computers 910 include desktops, servers, mobile devices (e.g., smart phones and laptops), wearables, virtual reality devices, augmented reality devices, expanded reality devices, spatial computing devices, virtualized devices, other computers, or combinations thereof. In particular example implementations, the computing environment 900 includes at least one physical computer.

The computing environment 900 may specifically be used to implement one or more aspects described herein. In some examples, one or more of the computers 910 may be implemented as a client device, such as mobile device and others of the computers 910 may be used to implement aspects of a machine learning framework useable to train and deploy models exposed to the mobile device or provide other functionality, such as through exposed application programming interfaces.

The computing environment 900 can be arranged in any of a variety of ways. The computers 910 can be local to or remote from other computers 910 of the computing environment 900. The computing environment 900 can include computers 910 arranged according to client-server models, peer-to-peer models, edge computing models, other models, or combinations thereof.

In many examples, the computers 910 are communicatively coupled with devices internal or external to the computing environment 900 via a network 920.

In some implementations, computers 910 can be general-purpose computing devices (e.g., consumer computing devices). In some instances, via hardware or software configuration, computers 910 can be special purpose computing devices, such as servers able to practically handle large amounts of client traffic, machine learning devices able to practically train machine learning models, data stores able to practically store and respond to requests for large amounts of data, other special purposes computers, or combinations thereof. The relative differences in capabilities of different kinds of computing devices can result in certain devices specializing in certain tasks. For instance, a machine learning model may be trained on a powerful computing device and then stored on a relatively lower powered device for use.

Many example computers 910 include one or more processors 912, memory 914, and one or more interfaces 918. Such components can be virtual, physical, or combinations thereof.

The one or more processors 912 are components that execute instructions, such as instructions that obtain data, process the data, and provide output based on the processing. The one or more processors 912 often obtain instructions and data stored in the memory 914. The one or more processors 912 can take any of a variety of forms, such as central processing units, graphics processing units, coprocessors, tensor processing units, artificial intelligence accelerators, microcontrollers, microprocessors, application-specific integrated circuits, field programmable gate arrays, other processors, or combinations thereof. In example implementations, the one or more processors 912 include at least one physical processor implemented as an electrical circuit. Example providers of processors 912 include INTEL, AMD, QUALCOMM, TEXAS INSTRUMENTS, and APPLE.

The memory 914 is a collection of components configured to store instructions 916 and data for later retrieval and use. The instructions 916 can, when executed by the one or more processors 912, cause execution of one or more operations that implement aspects described herein. In many examples, the memory 914 is a non-transitory computer readable medium, such as random-access memory, read only memory, cache memory, registers, portable memory (e.g., enclosed drives or optical disks), mass storage devices, hard drives, solid state drives, other kinds of memory, or combinations thereof. In certain circumstances, transitory memory 914 can store information encoded in transient signals.

The one or more interfaces 918 are components that facilitate receiving input from and providing output to something external to the computer 910, such as visual output components (e.g., displays or lights), audio output components (e.g., speakers), haptic output components (e.g., vibratory components), visual input components (e.g., cameras), auditory input components (e.g., microphones), haptic input components (e.g., touch or vibration sensitive components), motion input components (e.g., mice, gesture controllers, finger trackers, eye trackers, or movement sensors), buttons (e.g., keyboards or mouse buttons), position sensors (e.g., terrestrial or satellite-based position sensors such as those using the Global Positioning System), other input components, or combinations thereof (e.g., a touch sensitive display). The one or more interfaces 918, such as a communication interface, can include components for sending or receiving data from other computing environments or electronic devices, such as one or more wired connections (e.g., Universal Serial Bus connections, THUNDERBOLT connections, ETHERNET connections, serial ports, or parallel ports) or wireless connections (e.g., via components configured to communicate via radiofrequency signals, such as according to WI-FI, cellular, BLUETOOTH, ZIGBEE, or other protocols). One or more of the one or more interfaces 918 can facilitate connection of the computing environment 900 to a network 920.

The network 920 is a set of devices that facilitate communication from a sender to a destination, such as by implementing communication protocols. Example networks include local area networks, wide area networks, private networks such as an intranet, public networks such as the Internet, or any combination thereof. The network may include any wired or wireless communication network including, for example, a wired or wireless local area network (LAN), personal area network (PAN), metropolitan area network (MAN), wide area network (WAN), or the like, as well as any hardware, software and firmware required to implement it (such as, e.g., network routers, etc.). For example, communications network may include a cellular telephone, an 802.11, 802.16, 802.20, or WiMax network. The network may utilize a variety of networking protocols now available or later developed including, but not limited to Transmission Control Protocol, Internet Protocol, etc.

The computers 910 can include any of a variety of other components to facilitate performance of operations described herein. Example components include one or more power units (e.g., batteries, capacitors, power harvesters, or power supplies) that provide operational power, one or more busses to provide intra-device communication, one or more cases or housings to encase one or more components, other components, or combinations thereof.

A person of skill in the art, having benefit of this disclosure, may recognize various ways for implementing technology described herein, such as by using any of a variety of programming languages (e.g., a C-family programming language, PYTHON, JAVA, RUST, HASKELL, other languages, or combinations thereof), libraries or packages (e.g., that provide functions for obtaining, processing, and presenting data, such as may be obtained using a package manager like PIP or CONDA), compilers, and interpreters to implement aspects described herein. Example libraries include NLTK (Natural Language Toolkit) by Team NLTK (providing natural language functionality), PYTORCH by META (providing machine learning functionality), NUMPY by the NUMPY Developers (providing mathematical functions), and BOOST by the Boost Community (providing various data structures and functions) among others. Operating systems (e.g., WINDOWS, LINUX, MACOS, IOS, and ANDROID) may provide their own libraries or application programming interfaces useful for implementing aspects described herein, including user interfaces and interacting with hardware or software components. Web applications can also be used, such as those implemented using JAVASCRIPT or another language. A person of skill in the art, with the benefit of the disclosure herein, can use programming tools to assist in the creation of software or hardware to achieve techniques described herein, such as intelligent code completion tools (e.g., INTELLISENSE) and artificial intelligence tools (e.g., GITHUB COPILOT by MICROSOFT or CODE LLAMA by META).

In some examples, large language models can be used to understand natural language, generate natural language, or perform other tasks. Examples of such large language models include CHATGPT by OPENAI, a LLAMA model by META, a CLAUDE model by ANTHROPIC, others, or combinations thereof. Such models can be fine-tuned on relevant data using any of a variety of techniques to improve the accuracy and usefulness of the answers. The models can be run locally on server or client devices or accessed via an application programming interface. Some of those models or services provided by entities responsible for the models may include other features, such as speech-to-text features, text-to-speech, image analysis, research features, and other features, which may also be used as applicable.

### Example Machine Learning Framework

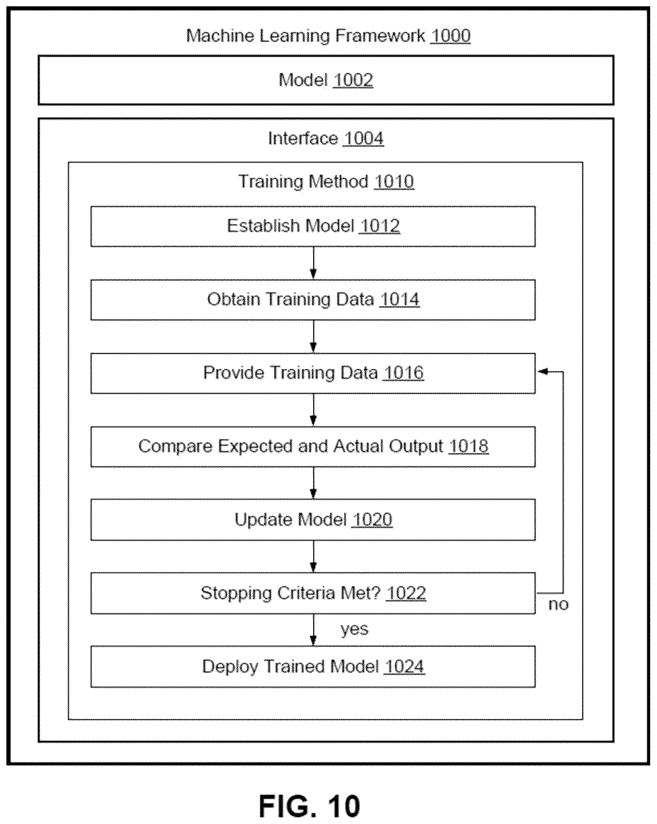

FIG. 10 illustrates an example machine learning framework 1000 that techniques described herein may benefit from or improve on. A machine learning framework 1000 is a collection of software and data that implements artificial intelligence trained to provide output, such as predictive data, based on input. Examples of artificial intelligence that can be implemented with machine learning way include neural networks (including recurrent neural networks), language models (including so-called “large language models”), generative models, natural language processing models, adversarial networks, decision trees, Markov models, support vector machines, genetic algorithms, others, or combinations thereof. A person of skill in the art having the benefit of this disclosure will understand that these artificial intelligence implementations need not be equivalent to each other and may instead select from among them based on the context in which they will be used. Machine learning frameworks 1000 or components thereof are often built or refined from existing frameworks, such as TENSORFLOW by GOOGLE, INC. or PYTORCH by the PYTORCH community. The machine learning frameworks 1000 may correspond to techniques as leveraged by the various data processors as described herein for various data processing functions.

The machine learning framework 1000 can include one or more models 1002 that are the structured representation of learning and an interface 1004 that supports use of the model 1002. The model 1002 may include can take any of a variety of forms. In many examples, the model 1002 includes representations of nodes (e.g., neural network nodes, decision tree nodes, Markov model nodes, other nodes, or combinations thereof) and connections between nodes (e.g., weighted or unweighted unidirectional or bidirectional connections). In certain implementations, the model 1002 can include a representation of memory (e.g., providing long short-term memory functionality). Where the set includes more than one model 1002, the models 1002 can be linked, cooperate, or compete to provide output.

The interface 1004 can include software procedures (e.g., defined in a library) that facilitate the use of the model 1002, such as by providing a way to establish and interact with the model 1002. For instance, the software procedures can include software for receiving input, preparing input for use (e.g., by performing vector embedding, such as using Word2Vec, BERT, or another technique), processing the input with the model 1002, providing output, training the model 1002, performing inference with the model 1002, fine tuning the model 1002, other procedures, or combinations thereof.

In an example implementation, interface 1004 can be used to facilitate a training method 1010. The training method 1010 may therefore include or be used to implement operation 224 of FIG. 2. The training method 1010 may include operation 1012, which includes establishing a model 1002, such as initializing a model 1002. The establishing can include setting up the model 1002 for further use (e.g., by training or fine tuning). The model 1002 can be initialized with values. In examples, the model 1002 can be pretrained.

Operation 1014 can follow operation 1012. Operation 1014 includes obtaining training data; in many examples, the training data includes pairs of input (e.g., training sequence data objects and respective contextual data objects) and desired output (e.g., labels) given the input. In supervised or semi-supervised training, the data can be prelabeled, such as by human or automated labelers. In unsupervised learning the training data can be unlabeled.

Many examples herein are related to supervised prediction of disruptions to pinpoint the weights or importance of events. But certain embodiments may operate without explicit labels but with implicit labels computed based on other data, thus data need not be explicitly labeled. But it can be beneficial to use an input labeler to infer labels and to train a supervised model.

The training data can include validation data used to validate the trained model 1002. Operation 1016 can follow operation 1014. Operation 1016 includes providing a portion of the training data to the model 1002. This can include providing the training data in a format usable by the model 1002. The machine learning framework 1000 (e.g., via the interface 1004) can cause the model 1002 to produce an output based on the input.

Operation 1018 can follow operation 1016. Operation 1018 includes comparing the expected output with the actual output. In an example, this can include applying a loss function to determine the difference between expected and actual data. This value can be used to determine how training is progressing. Operation 1020 can follow operation 1018. Operation 1020 includes updating the model 1002 based on the result of the comparison. This can take any of a variety of forms depending on the nature of the model 1002. Where the model 1002 includes weights, the weights can be modified to increase the likelihood that the model 1002 will produce correct output given an input. Depending on the model 1002, backpropagation or other techniques can be used to update the model 1002.

Operation 1022 can follow operation 1020. Operation 1022 includes determining whether a stopping criterion has been reached, such as based on the output of the loss function (e.g., actual value or change in value over time). In addition, or instead, whether the stopping criterion has been reached can be determined based on a number of training epochs that have occurred or an amount of training data that has been used. In some examples, satisfaction of the stopping criterion can include if the stopping criterion has not been satisfied, the flow of the method can return to operation 1014. If the stopping criterion has been satisfied, the flow can move to operation 1022.

Operation 1024 includes deploying the trained model 1002 for use in production, such as providing the trained model 1002 with real-world input data and produce output data used in a real-world process. The model 1002 can be stored in memory 914 of at least one computer 910 or distributed across memories of two or more such computers 910 for production of output data.

The use of a computer and network implemented system in generating outputs, and associated electronic communications, enables leveraging of machine learning processes, neural networks, and attention mechanisms to efficiently extract meaningful outputs from large datasets, by embedding respective contextual data in the attention mechanism along with respective sequence data objects. Accordingly, example embodiments provide improvements over systems that merely process input sequences, or sequence data objects, without context. The improvements may be realized with input data that spans long timeframes of multiple sequence events. The generated outputs are also more accurate and are able to detect latent and hidden relationships between multiple sequenced events.

Example embodiments may simultaneously consider multiple types of contextual data objects (e.g., subsequence contexts, token-level contexts, and token-to-token contexts). Example embodiments, learn, understand, and predict latent pattern of data not only considering the sequence data object, such as transactional data, but further contextualize each sequence within its context-including any known subsequence contexts, token-level contexts, and token-to-token contexts. Example embodiments further leverage the attention mechanism to provide an importance scoring or weighting of the features within an input sequence as well as in the contextual data.

Additionally, example embodiments may create one model across all subjects and entities, to make generalization across users, demographics, or other groupings of people or entire populations. Example embodiments may therefore generate a foundational model that directly enables various downstream application and tasks.

By sharing model parameters and applying transfer learning techniques across customers, example embodiments can leverage the knowledge gained from one customer's transactional data to improve the forecasting for another. This transfer of learning allows the model to generalize across customers and capture common patterns and trends, resulting in more accurate predictions.

Where implementations involve personal or corporate data, that data can be stored in a manner consistent with relevant laws and with a defined privacy policy. In certain circumstances, the data can be decentralized, anonymized, or fuzzed to reduce the amount of accurate private data that is stored or accessible at a particular computer. The data can be stored in accordance with a classification system that reflects the level of sensitivity of the data and that encourages human or computer handlers to treat the data with a commensurate level of care.

Where implementations involve machine learning, machine learning can be used according to a defined machine learning policy. The policy can encourage training of a machine learning model with a diverse set of training data. Further, the policy can encourage testing for and correcting undesirable bias embodied in the machine learning model. The machine learning model can further be aligned such that the machine learning model tends to produce output consistent with a predetermined morality. Where machine learning models are used in relation to a process that makes decisions affecting individuals, the machine learning model can be configured to be explainable such that the reasons behind the decision can be known or determinable. The machine learning model can be trained or configured to avoid making decisions based on protected characteristics.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous.

Moreover, the separation of various system components in the embodiments described above should not be understood as requiring such separation in all embodiments, and it should be understood that the described program components and systems can generally be integrated together in a single software product or packaged into multiple software products.

Thus, embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

The various embodiments described herein are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims. Although specific terms are employed herein, they are used in a generic and descriptive sense only and not for purposes of limitation.

1. A mobile device locally hosting an application via which a user can interact with one or more remote services, the application comprising a local fraud detection model, wherein the mobile device comprises one or more processors and at least one non-transitory memory storing instructions that, when executed by the one or more processors, cause the one or more processors to:
run the application on the mobile device;
responsive to a user input to the application, via a user interface, generate transaction data object comprising a transaction dataset associated with a transaction attempt executed using the application, the transaction dataset comprising one or more device specific characteristics generated by the mobile device in association with the transaction attempt;
extract, from the transaction dataset, one or more transaction object features, the one or more transaction object features comprising mobile device platform specific features associated with the one or more device specific characteristics;
generate, in real time by processing the one or more transaction object features using the local fraud detection model executed locally by the application on the mobile device, a fraudulent risk score using the one or more transaction object features, wherein the local fraud detection model is (i) configured for execution using a set of resources available for local model execution, (ii) a machine learning model trained based on a historical transaction dataset and a historical user transaction dataset, (iii) configured with a set of parameters specific to a platform platform associated with the mobile device, (iv) and integrated directly within the application, wherein generating the fraudulent risk score comprises:
for a subject transaction feature of the one or more transaction object features, determining a set of feature variance metrics defining a degree of variance between the subject transaction feature and an associated baseline transaction pattern object feature of a user profile, and
generating the fraudulent risk score based on an aggregation of a plurality of sets of feature variance metrics associated with the one or more transaction object features, including the mobile device platform specific features;
in an instance in which the fraudulent risk score exceeds a fraudulent risk score threshold, block, via the application on the mobile device, access to one or more account assets associated with the transaction data object and locally blocking the transaction attempt; and
in an instance in which the fraudulent risk score does not exceed the fraudulent risk score threshold, transmit a portion of the transaction dataset associated with the transaction attempt to a backend system without at least a portion of the one or more device specific characteristics generated by the mobile device.

2. The mobile device of claim 1, wherein the local fraud detection model is trained according to normalized historical online transaction data.

3. The mobile device of claim 2, wherein the local fraud detection model is trained according to features extracted from the normalized historical online transaction data.

4. The mobile device of claim 1, wherein the local fraud detection model is trained according to scaled data corresponding to any of spending patterns, frequency, or geographic locations of transactions.

5. The mobile device of claim 1, wherein the at least one non-transitory memory further stores instructions that, when executed by the one or more processors, cause the one or more processors to:
determine, based on the historical transaction dataset, a baseline user transaction data structure with respect to a plurality of historical transactions.

6. The mobile device of claim 5, wherein the local fraud detection model is trained based on the historical transaction dataset and the baseline user transaction data structure.

7. The mobile device of claim 1, wherein the at least one non-transitory memory further stores instructions that, when executed by the one or more processors, cause the one or more processors to:
receive, from a remote server system, federated learning data corresponding to one or more additional client devices configured to implement one or more additional machine learning models; and
update the local fraud detection model based on the federated learning data.

8. The mobile device of claim 1, wherein the application is a mobile application configured to enable user access to an entity responsible for managing user transactions.

9. The mobile device of claim 1, wherein the application is a web browser application by which a user can access a web platform associated with an entity responsible for managing user transactions.

10. The mobile device of claim 8, wherein (i) the user profile is platform-specific to user accesses via the mobile application, and (ii) the local fraud detection model is configured with a first set of parameters specific to user accesses via the mobile application.

11. The mobile device of claim 9, wherein (i) the user profile is platform-specific to user accesses via the web browser application, and (ii) the local fraud detection model is configured with a second set of parameters specific to user accesses via the web browser application.

12. The mobile device of claim 1, wherein the at least one non-transitory memory further stores instructions that, when executed by the one or more processors, cause the one or more processors to:
update the user profile based on the transaction attempt responsive to a determination that the fraudulent risk score does not exceed a predefined threshold.

13. The mobile device of claim 1, wherein the at least one non-transitory memory further stores instructions that, when executed by the one or more processors, cause the one or more processors to:
in an instance in which the fraudulent risk score exceeds a predefined threshold lower than the fraudulent risk score threshold, trigger a multifactor authentication mechanism; and
in response to determining successful completion of the multifactor authentication mechanism, transmitting a portion of the transaction dataset associated with the transaction attempt to a backend system without at least a portion of the one or more device specific characteristics generated by the mobile device.

14. One or more non-transitory computer-readable storage media including instructions that, when executed by one or more processors, cause the one or more processors to:
run, on a mobile device, an application via which a user can interact with one or more remote services, wherein the application comprises a local fraud detection model;
responsive to a user input to the application, via a user interface, generate transaction data object comprising a transaction dataset associated with a transaction attempt executed using the application, the transaction dataset comprising one or more device specific characteristics generated by the mobile device in association with the transaction attempt;
extract, from the transaction dataset, one or more transaction object features, the one or more transaction object features comprising mobile device platform specific features associated with the one or more device specific characteristics;
generate, in real time by processing the one or more transaction object features using the local fraud detection model executed locally by the application on the mobile device, a fraudulent risk score using the one or more transaction object features, wherein the local fraud detection model is (i) configured for execution using a set of resources available for local model execution, (ii) a machine learning model trained based on a historical transaction dataset and a historical user transaction dataset, (iii) configured with a set of parameters specific to a platform associated with the mobile device, (iv) and integrated directly within the application, wherein generating the fraudulent risk score comprises:
for a subject transaction feature of the one or more transaction object features, determining a set of feature variance metrics defining a degree of variance between the subject transaction feature and an associated baseline transaction pattern object feature of a user profile, and
generating the fraudulent risk score based on an aggregation of a plurality of sets of feature variance metrics associated with the one or more transaction object features, including the mobile device platform specific features;
in an instance in which the fraudulent risk score exceeds a fraudulent risk score threshold, block, via the application on the mobile device, access to one or more account assets associated with the transaction data object and locally blocking the transaction attempt; and
in an instance in which the fraudulent risk score does not exceed the fraudulent risk score threshold, transmit a portion of the transaction dataset associated with the transaction attempt to a backend system without at least a portion of the one or more device specific characteristics generated by the mobile device.

15. The one or more non-transitory computer-readable storage media of claim 14, further including instructions that, when executed by the one or more processors, cause the one or more processors to:
determine, based on the historical transaction dataset, a baseline user transaction data structure with respect to a plurality of historical transactions.

16. The one or more non-transitory computer-readable storage media of claim 14, further including instructions that, when executed by the one or more processors, cause the one or more processors to:
receive, from a remote server system, federated learning data corresponding to one or more additional client devices configured to implement one or more additional machine learning models; and
update the local fraud detection model based on the federated learning data.

17. A computer-implemented method comprising:
running, by one or more processors and on a mobile device, an application via which a user can interact with one or more remote services, wherein the application comprises a local fraud detection model;
responsive to a user input to the application, via a user interface, generating by the one or more processors, a transaction data object comprising a transaction dataset associated with a transaction attempt executed using the application, the transaction dataset comprising one or more device specific characteristics generated by the mobile device in association with the transaction attempt;
extracting, by the one or more processors and from the transaction dataset, one or more transaction object features, the one or more transaction object features comprising mobile device platform specific features associated with the one or more device specific characteristics;
generating, by the one or more processors and in real time by processing the one or more transaction object features using the local fraud detection model executed locally by the application on the mobile device, a fraudulent risk score using the one or more transaction object features, wherein the local fraud detection model is (i) configured for execution using a set of resources available for local model execution, (ii) a machine learning model trained based on a historical transaction dataset and a historical user transaction dataset, (iii) configured with a set of parameters specific to a platform associated with the mobile device, (iv) and integrated directly within the application, wherein generating the fraudulent risk score comprises:
for a subject transaction feature of the one or more transaction object features, determining a set of feature variance metrics defining a degree of variance between the subject transaction feature and an associated baseline transaction pattern object feature of a user profile, and
generating the fraudulent risk score based on an aggregation of a plurality of sets of feature variance metrics associated with the one or more transaction object features, including the mobile device platform specific features;
in an instance in which the fraudulent risk score exceeds a fraudulent risk score threshold, blocking, by the one or more processors and via the application on the mobile device, access to one or more account assets associated with the transaction data object and locally blocking the transaction attempt; and
in an instance in which the fraudulent risk score does not exceed the fraudulent risk score threshold, transmitting, by the one or more processors, a portion of the transaction dataset associated with the transaction attempt to a backend system without at least a portion of the one or more device specific characteristics generated by the mobile device.

18. The computer-implemented method of claim 17, further comprising:
determining, by the one or more processors and based on the historical transaction dataset, a baseline user transaction data structure with respect to a plurality of historical transactions.

19. The computer-implemented method of claim 17, further comprising:
updating, by one or more processors, the user profile based on the transaction attempt responsive to a determination that the fraudulent risk score does not exceed a predefined threshold.

20. The computer-implemented method of claim 17, further comprising:
receiving, by the one or more processors and from a remote server system, federated learning data corresponding to one or more additional client devices configured to implement one or more additional machine learning models; and
updating, by one or more processors, the local fraud detection model based on the federated learning data.

21. The mobile device of claim 1, wherein the one or more device specific characteristics comprise biometrics interaction data gathered by the mobile device, and wherein the fraudulent risk score is generated based on a biometrics interaction pattern feature of the one or more transaction object features by determining a set of biometrics interaction variance metrics defining a biometrics interaction degree of variance between the biometrics interaction pattern feature and an associated biometrics interaction baseline transaction pattern object.

22. The mobile device of claim 1, wherein the one or more device specific characteristics comprise device specific location signals gathered by the mobile device, and wherein the fraudulent risk score is generated based on a device specific location feature of the one or more transaction object features by determining a set of device specific location variance metrics defining a location degree of variance between the device specific location feature and an associated location baseline transaction pattern object.

23. The mobile device of claim 1, wherein the local fraud detection model comprises a TensorFlow or Core ML model.
